(19) United States
(12) Patent Application Publication
(10) Pub. No.: US 2014/0299345 A1
(43) Pub. Date: Oct. 9, 2014

(54) HAND-HELD TOOLS AND COMPONENTS THEREOF

(71) Applicant: Campbell Hausfeld / Scott Fetzer Company, Harrison, OH (US)

(72) Inventors: Jason Kyle McRoberts, Hamilton, OH (US); Berlie Eugene Parks, Lawrenceburg, IN (US); Douglas Robert Harper, Harrison, OH (US); Katie Nicole Lay, Cincinnati, OH (US)

(21) Appl. No.: 14/308,344

(22) Filed: Jun. 18, 2014

Related U.S. Application Data
(63) Continuation of application No. PCT/US2012/072147, filed on Dec. 28, 2012.
(60) Provisional application No. 61/581,731, filed on Dec. 30, 2011.
(60) Provisional application No. 61/646,594, filed on May 14, 2012.

(51) Int. Cl. B25F 5/00; B23Q 5/06

(52) U.S. Cl. CPC B25F 5/006; B25F 5/00; B23Q 5/06
USPC 173/162.2; 173/213; 173/218

(57) ABSTRACT

A hand-held oscillating tool has a linear motor and an accessory attachment mechanism configured for releasable coupling to an accessory blade.

### CROSS REFERENCE TO RELATED APPLICATIONS

This application claims the priority benefit of U.S. Provisional Patent Application Ser. No. 61/581,731, “Pneumatic Tools, Components Thereof and Methods”, filed Dec. 30, 2011, and Ser. No. 61/646,594, “Pneumatic Tools, Components Thereof and Methods”, filed May 14, 2012, the entire disclosures of which are hereby expressly incorporated by reference herein.

### TECHNICAL FIELD

This application relates generally to a hand-held oscillating tool and components thereof.

### BACKGROUND

A hand-held oscillating tool has a motor and an accessory attachment mechanism for supporting an accessory blade. Operation of the hand-held oscillating tool can oscillate the accessory blade for use on a work surface.

### SUMMARY

In accordance with one embodiment, a hand-held tool comprises a housing, a head assembly, an air inlet, a pneumatic linear motor, a transmission assembly, and at least one resilient member. The housing defines a motor compartment. The head assembly defines a head compartment. The air inlet is supported by the housing. The pneumatic linear motor is disposed at least partially within the motor compartment and comprises a piston. The piston comprises a shaft. The piston is configured for reciprocation between a forward position and a rearward position. The transmission assembly is coupled to the shaft and is disposed at least partially within at least one of the motor compartment and the head compartment. The at least one resilient member is disposed at least partially within the head compartment adjacent the transmission assembly and is configured for selective contact with one of the transmission assembly and the shaft when the piston is in one of its forward position and rearward position to facilitate dampening of the piston.

In accordance with another embodiment, a hand-held tool comprises a housing, a head assembly, a linear motor, and a transmission assembly. The housing defines a motor compartment. The head assembly is rotatably coupled with the housing and defines a head compartment. The linear motor is disposed at least partially within the motor compartment and comprises a piston. The piston comprises a shaft and is configured for reciprocation. The transmission assembly is coupled to the shaft and is disposed at least partially in at least one of the motor compartment and the head compartment. Each of the transmission assembly, the piston and the head assembly are rotatable together.

In accordance with yet another embodiment, a hand-held tool comprises a housing, a head assembly, an air inlet, a pneumatic linear motor, and a transmission assembly. The housing defines a motor compartment. The head assembly defines a head compartment. The air inlet is supported by the housing. The pneumatic linear motor is disposed at least partially within the air motor compartment and comprises a piston. The piston comprises a shaft. The piston is configured for reciprocation along a longitudinal axis. The transmission assembly is disposed at least partially in at least one of the motor compartment and the head compartment. The transmission assembly comprises a cam that defines a slot. A centerline bisects the slot and the slot is angled with respect to the longitudinal axis such that the centerline and the longitudinal axis form an acute angle.

In accordance with yet another embodiment, a hand-held tool comprises a housing, an air inlet, a pneumatic linear motor, and a transmission assembly. The housing defines a motor compartment. The air inlet is supported by the housing. The pneumatic linear motor is disposed at least partially within the air motor compartment and comprises a piston. The piston comprises a shaft. The piston is configured for reciprocation along a longitudinal axis. The transmission assembly is disposed at least partially in one of the motor compartment and the head compartment. The transmission assembly comprises a boss and a cam. The boss is coupled to the shaft of the piston. The cam is pivotally coupled with the boss and is configured to interact with a support a bearing of an accessory attachment mechanism to facilitate pivoting of the accessory attachment mechanism about a pivotal axis.

In accordance with still another embodiment, an oscillating hand-held tool comprises a housing, a head assembly, a tool free attachment, and an accessory release handle. The housing defines a motor compartment. The head assembly is coupled with the housing and defines a head compartment. The tool free attachment assembly is pivotally supported by the head assembly and is at least partially disposed within the head compartment. The tool free attachment assembly comprises a sleeve, a plunger, a spring, and an accessory disk. The plunger is disposed at least partially within the sleeve and is movable between a clamping position and a depressed position. The spring is associated with the plunger and is configured to bias the plunger into the clamping position. The accessory disk is associated with the plunger and is configured to alternatively engage and release an accessory blade depending upon whether the plunger is in the clamping position and the depressed position, respectively. The accessory release handle is pivotally coupled with the head assembly and overlies the plunger. Depression of the accessory release handle facilitates movement of the plunger into the depressed position.

In accordance with still another embodiment, an oscillating hand-held tool comprises a housing, a head assembly, an accessory attachment mechanism, and an accessory disk. The housing defines a motor compartment. The head assembly is coupled with the housing and defines a head compartment. The accessory attachment mechanism is pivotally supported by the head assembly and is at least partially disposed within the head compartment. The accessory disk is associated with the accessory attachment mechanism and is configured to alternatively engage and release an accessory blade. The accessory disk defines a central aperture and comprises an inner edge, an outer edge, and a plurality of ovular protrusions. The inner edge borders the central aperture. The plurality of ovular protrusions is disposed circumferentially about the inner edge and is spaced substantially evenly from one another. Each of the ovular protrusions is generally frustoconically shaped.

In accordance with still another embodiment, an oscillating hand-held tool comprises a housing, a head assembly, a pneumatic linear motor, a trigger assembly, and an accessory attachment mechanism. The housing defines a motor compartment. The head assembly is coupled with the housing and defines a head compartment. The pneumatic linear motor is disposed at least partially within the motor compartment and defines at least one first exhaust port that is configured to permit passage of exhaust fluid during operation of the pneumatic linear motor. The trigger assembly is associated with the pneumatic linear motor and is configured for selective actuation to facilitate operation of the linear motor. The accessory attachment mechanism is coupled with the pneumatic linear motor and is pivotally supported by the head assembly. The accessory attachment mechanism is at least partially disposed within the head compartment and is configured to support an accessory blade. At least one of the housing and the head assembly defines at least one second exhaust port that is in fluid communication with said at least one first exhaust port. Said at least one second exhaust port is located along a lower portion of the oscillating hand-held tool. Said at least one second exhaust port is configured to direct the exhaust fluid from said at least one first exhaust port towards the accessory blade during operation of the linear motor.

In accordance with still another embodiment, a hand-held tool comprises a housing, a head assembly, an air inlet, a pneumatic linear motor, and a flow control collar. The housing defines a motor compartment. The head assembly defines a head compartment. The air inlet is supported by the housing. The air inlet defines an inlet passageway, a first port, a second port, and an outlet passageway. The first port is in fluid communication with the inlet passageway. The second port is in fluid communication with the inlet passageway. The outlet passageway is spaced from each of the inlet passageway, the first port, and the second port. The pneumatic linear motor is disposed at least partially within the air motor compartment and comprises a piston that is configured for reciprocation between one of a forward position and a rearward position. The flow control collar is rotatably coupled with the air inlet and is rotatable with respect to the air inlet between a first position and a second position. The outlet passageway is in fluid communication with the pneumatic linear motor. When the flow control collar is in the first position, the first port is in fluid communication with the outlet passageway and is configured to distribute pressurized fluid to the outlet passageway at a first fluid flow rate. When the flow control collar is in the second position, the second port is in fluid communication with the outlet passageway and is configured to distribute pressurized fluid to the outlet passageway at a second fluid flow rate. The first and second fluid flow rates are different.

In accordance with still another embodiment, a hand-held tool comprises a housing, an air inlet, and a pneumatic linear motor. The housing defines a motor compartment. The air inlet is supported by the housing. The pneumatic linear motor is disposed at least partially within the motor compartment and comprises a piston, an outer housing, and a return spring. The piston comprises a shaft and a front surface. The piston is configured to reciprocate in response to pressurized air between one of a forward position and a rearward position. The outer housing defines an interior and comprises a front collar that defines an interior front shoulder. The return spring assembly is disposed entirely within the interior of the outer housing and comprises a front washer, a rear washer, and a spring. The front washer abuts the interior front shoulder. The rear washer abuts the front surface of the piston. The spring is sandwiched between each of the front washer and the rear washer and is configured to bias the piston into a rearward position. The front washer, the rear washer and the spring are circumferentially disposed about the shaft of the piston.

In accordance with still another embodiment, an accessory blade for use with a motorized hand-held tool is provided. The accessory blade comprises a working end and a shank end. The shank end defines a main opening, a first slot, a second slot, a third slot, and a plurality of apertures. The main opening has a first angled edge and a second angled edge that cooperate with each other to define a v-shaped opening and respectively terminate at a generally U-shaped edge. The first slot is in communication with the main opening. The second slot is in communication with the main opening. The third slot is in communication with the main opening. The first, second, and third slots are distributed about a circumference of the main opening such that they are provided in a substantially T-shaped formation. At least two of the apertures are distributed between the first slot and the second slot. At least two of the other ones of the apertures are distributed between the first slot and the third slot. At least one of the other ones of the apertures is disposed between the first angled edge and the second slot. At least one other one of the apertures is disposed between the second angled edge and the third slot.

In accordance with still another embodiment, a hand-held tool comprises a housing, a head assembly, an air inlet, and a pneumatic linear motor. The housing defines a motor compartment. The head assembly defines a head compartment. The air inlet is supported by the housing. The pneumatic linear motor is disposed at least partially within the motor compartment. The pneumatic linear motor comprises a piston, a valve seat, a cylinder end plate, and a flapper. The piston comprises a shaft and is configured for reciprocation between one of a forward position and a rearward position. The valve seat defines a first set of passageways and a second set of passageways. The first and second passageways are in selective fluid communication with the air inlet. The flapper is sandwiched between the valve seat and the cylinder end plate. The flapper is configured for movement between a first position and a second position in response to pressurized fluid through the first set of passageways and the second set of passageways, respectively. The piston is configured to move to the forward position when the flapper is in the first position and to the rearward position when the flapper is in the second position.

In accordance with still another embodiment, a hand-held tool comprises a housing, a head assembly, an air inlet, a pneumatic linear motor, and a transmission assembly. The housing defines a motor compartment. The head assembly defines a head compartment. The air inlet is supported by the housing. The pneumatic linear motor is disposed at least partially within the air motor compartment and comprises a piston configured for reciprocation along a longitudinal axis. The piston comprises a shaft and the shaft comprises a first geared surface and a second geared surface. The respective first and second geared surfaces are disposed on substantially opposite sides of the shaft. The transmission assembly is disposed at least partially in at least one of the motor compartment and the head compartment. The transmission assembly comprises a first gear, a second gear, and a third gear. The first gear is intermeshed with the first geared surface. The second gear is intermeshed with the second geared surface. The third gear is associated with the first and second gears and is configured to rotate about a rotational axis in response to reciprocation of the piston along the longitudinal axis.

### BRIEF DESCRIPTION OF THE DRAWINGS

It is believed that certain embodiments will be better understood from the following description taken in conjunction with the accompanying drawings in which:

FIG. 1 is a front perspective view depicting a hand-held oscillating tool with an accessory blade in accordance with one embodiment;

FIG. 2 is a cross-sectional view taken along the line 2-2 in FIG. 1 and depicting the hand-held oscillating tool of FIG. 1, wherein certain components of the hand-held pneumatic oscillating tool have been removed for clarity of illustration and wherein a piston and a flapper of a linear motor are shown in respective rearward positions;

FIG. 3 is a cross-sectional view similar to FIG. 2, but with the piston and the flapper shown in respective forward positions;

FIG. 4 is a partially exploded front perspective view depicting parts of the hand-held pneumatic oscillating tool of FIG. 2;

FIG. 5 is a further exploded front perspective view depicting some of the parts of FIG. 4;

FIG. 6 is an exploded rear perspective view depicting the parts of FIG. 5;

FIG. 7 is an enlarged front perspective view depicting one of the parts of FIG. 5;

FIG. 8 is a rear perspective view depicting the part of FIG. 7;

FIG. 9 is an enlarged rear perspective view depicting another one of the parts of FIG. 5;

FIG. 10 is an enlarged rear perspective view depicting yet another one of the parts of FIG. 5;

FIG. 11 is an exploded front perspective view depicting some of the parts of FIG. 4;

FIG. 12 is a further exploded perspective view depicting some of the parts of FIG. 4 corresponding to a tool free attachment assembly, according to one embodiment;

FIG. 13 is a cross-sectional view taken along the line 13-13 in FIG. 12;

FIG. 14 is an enlarged perspective view depicting the part of FIG. 13;

FIG. 15 is a perspective view depicting the accessory blade of FIG. 1;

FIG. 16 is a top plan view depicting the accessory blade of FIG. 15;

FIG. 17 is a top plan view depicting an accessory blade, according to another embodiment;

FIG. 18 is an exploded perspective view of a tool free attachment assembly, according to another embodiment

FIGS. 19-21 are front sectional views depicting various operating states of the tool free attachment assembly of FIG. 18;

FIGS. 22-23 are upper and lower perspective views depicting an accessory disk according to another embodiment;

FIGS. 24-25 are side elevational views depicting the accessory disk of FIG. 22;

FIGS. 26-27 are upper and lower plan views depicting the accessory disk of FIG. 22;

FIG. 28 is an upper plan view depicting the accessory disk of FIG. 22 in association with the accessory blade of FIG. 5 shown in dashed lines;

FIG. 29 is an upper perspective view depicting the arrangement of FIG. 28;

FIG. 30 is a side elevational view depicting the accessory disk and the accessory blade of FIG. 28;

FIG. 31 is a perspective view depicting some of the parts of FIG. 4 as assembled;

FIG. 32 is an enlarged perspective view depicting one of the parts of FIG. 4 as assembled;

FIG. 33 is an enlarged front perspective view depicting other parts of FIG. 4;

FIG. 34 is a cross-sectional view taken along the line 34-34 in FIG. 33.

FIG. 35 is an enlarged front perspective view depicting another part of FIG. 4;

FIG. 36 is a rear perspective view depicting the part of FIG. 35;

FIG. 37 is a cross-sectional view taken along the line 37-37 in FIG. 36;

FIG. 38 is a rear perspective view depicting one of the parts of FIG. 33;

FIG. 39 is a cross-sectional view depicting certain portions of a hand-held tool in accordance with another embodiment;

FIG. 40 is a perspective view depicting a transmission and a portion of a piston of a linear motor of the hand-held tool of FIG. 39;

FIG. 41 is a side elevational view depicting the arrangement of FIG. 40; and

FIG. 42 is a top plan view depicting the arrangement of FIG. 41.

### DETAILED DESCRIPTION

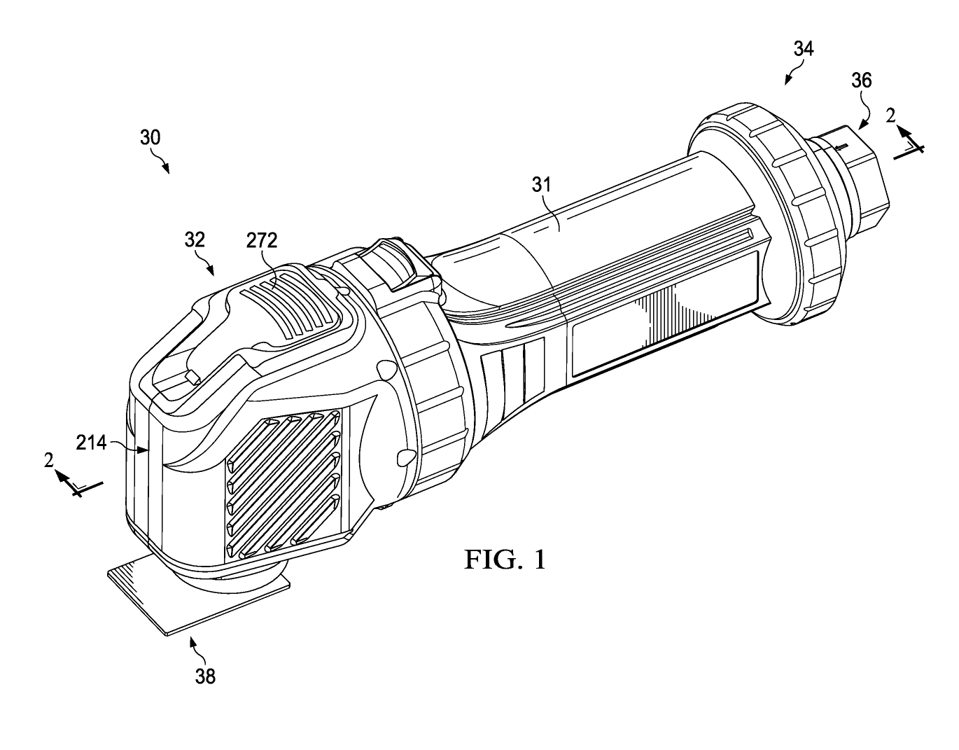

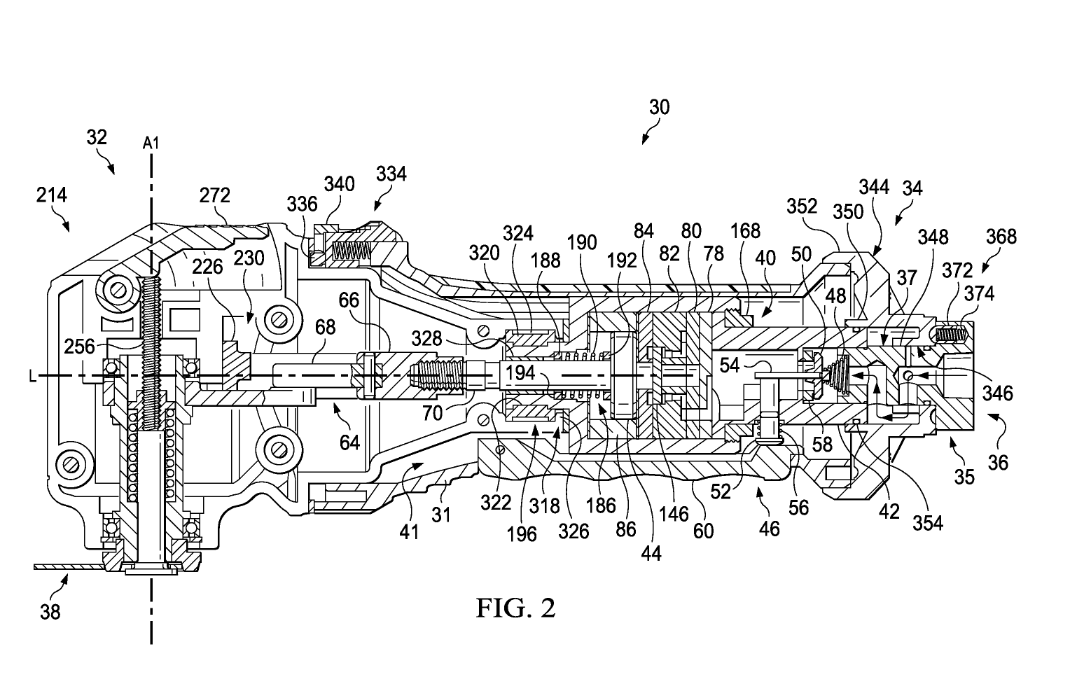

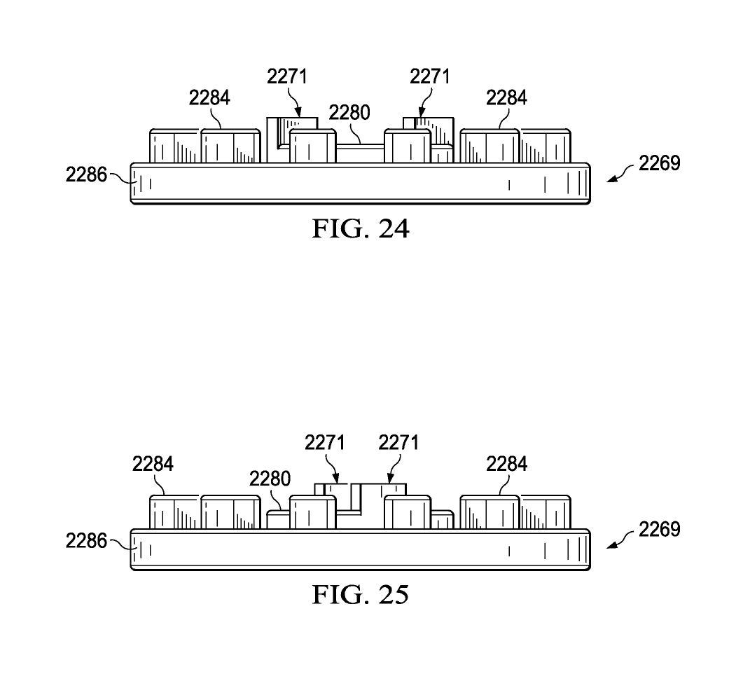

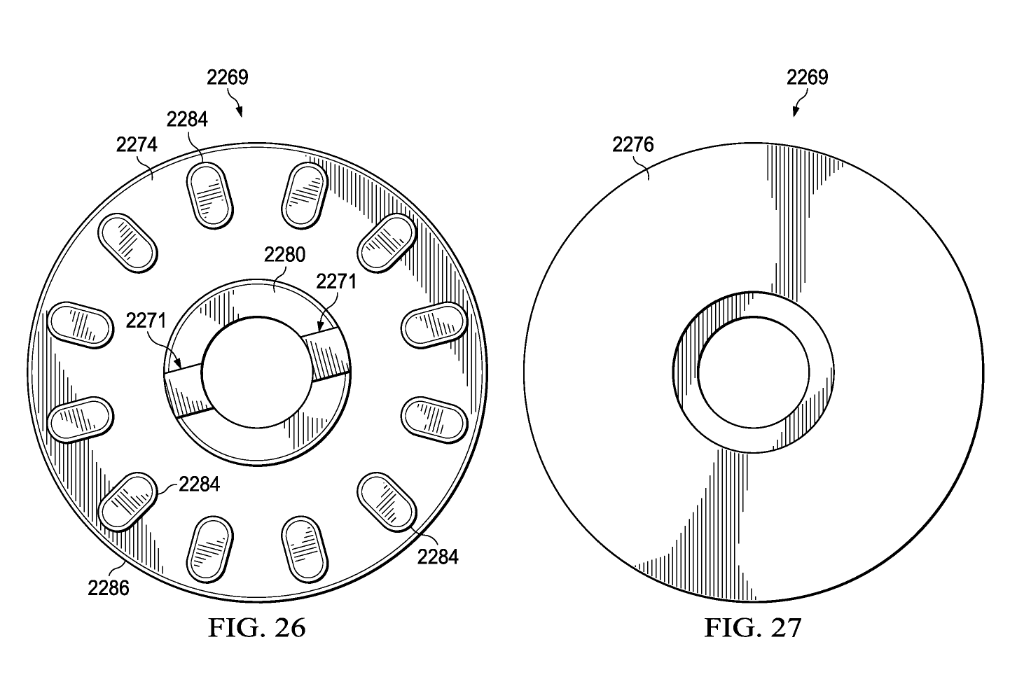

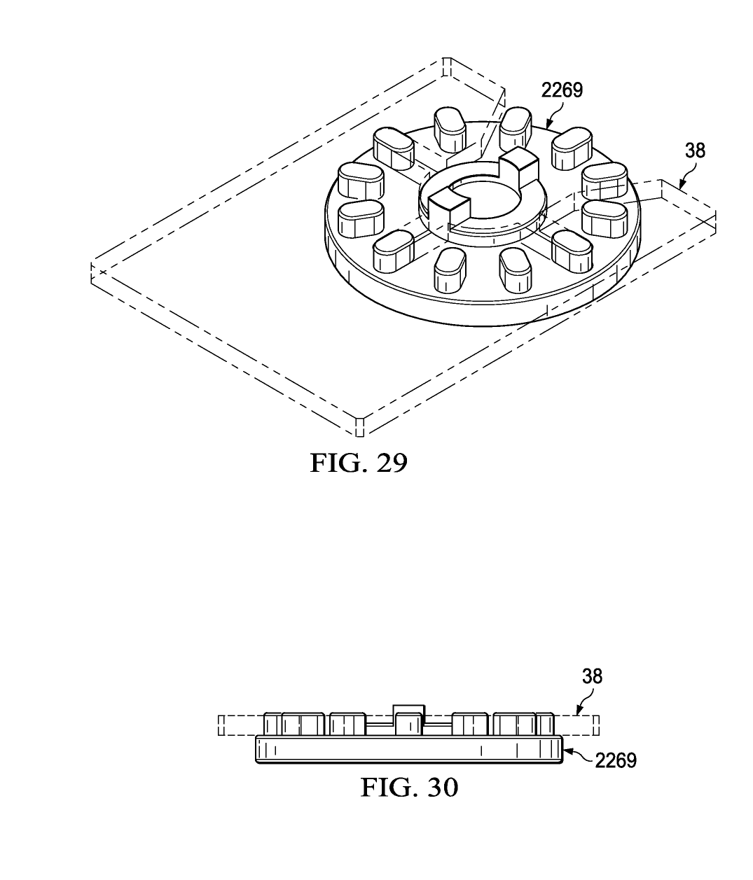

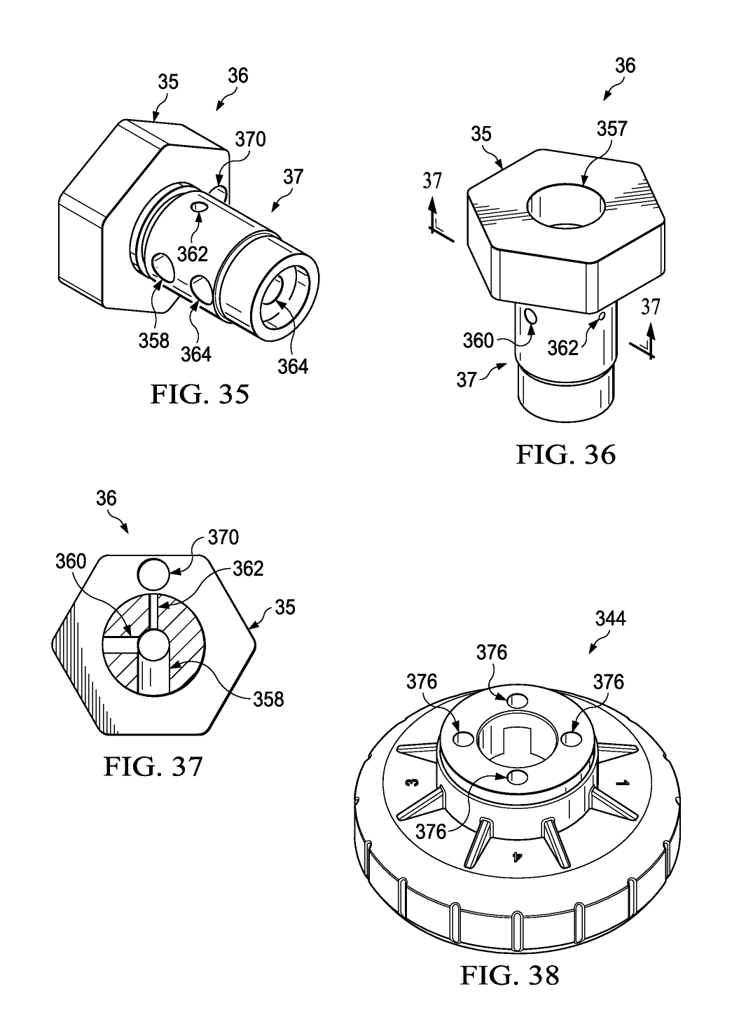

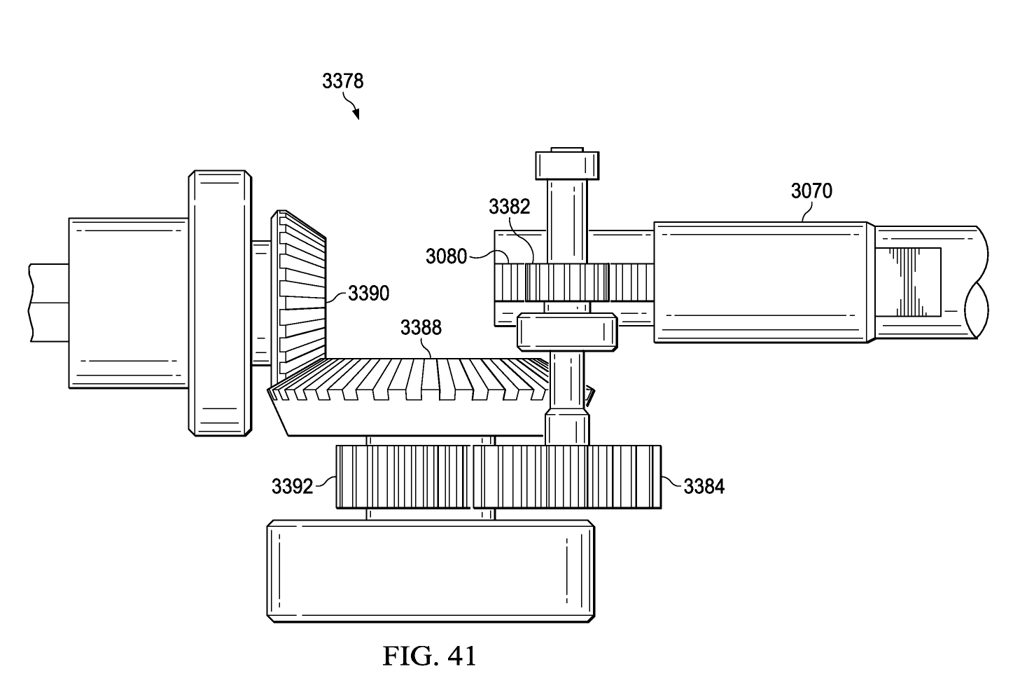

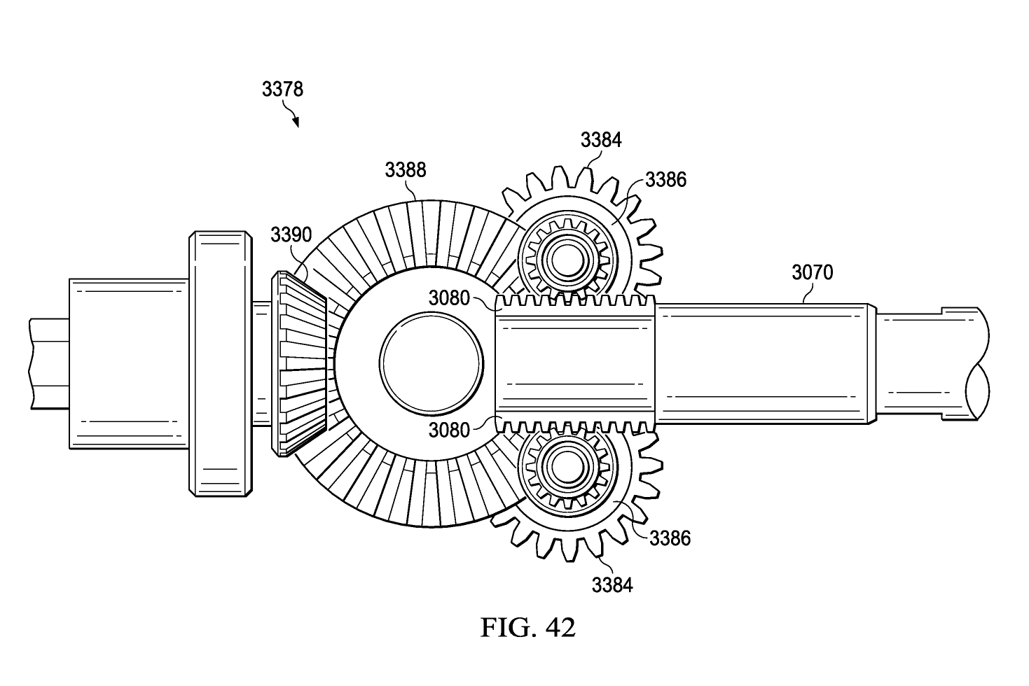

Embodiments are hereinafter described in detail in connection with the views and examples of FIGS. 1-42, wherein like numbers indicate the same or corresponding elements throughout the views. According to one embodiment, as illustrated in FIGS. 1 and 2, a hand-held pneumatic oscillating tool 30 (hereinafter “oscillating tool”) is provided that can include a housing 31 and can extend between a front end 32 and a rear end 34. As illustrated in FIG. 2, an air inlet 36 can be disposed at the rear end 34 and supported by the housing 31 and can include a base portion 35 and a stem portion 37. The base portion 35 of the air inlet 36 can be coupled with an air compressor (not shown) or another source of pressurized air or other fluid. The pressurized air can facilitate selective powering of the oscillating tool 30 which can actuate an accessory blade 38 such that the oscillating tool is operable as a hand-held cutting tool.

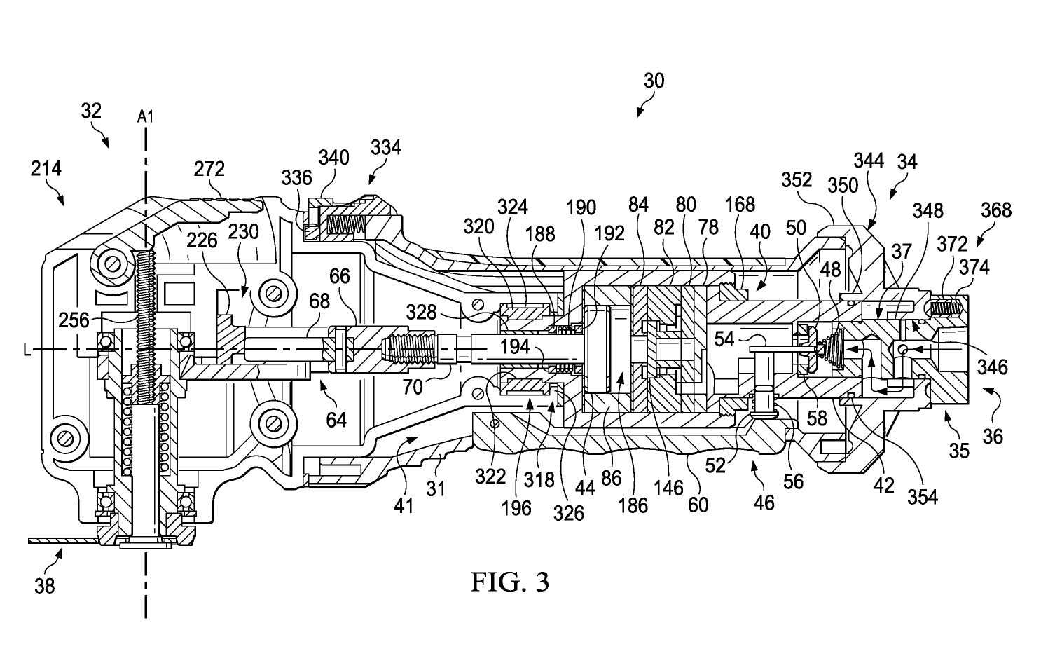

As illustrated in FIGS. 2-4, the oscillating tool 30 can include a linear motor 40. The linear motor 40 can be at least partially disposed within a motor compartment 41 defined by the housing 31. The linear motor 40 can be in fluid communication with the air inlet 36 and can be selectively powered with pressurized air from the air inlet 36. The linear motor 40 can include a piston 44 configured for reciprocation between one of a rearward position (FIG. 2) and a forward position (FIG. 3). In one embodiment, the piston 44 can be formed of a thermoplastic material in a unitary one-piece construction. In other embodiments, the piston 44 can be formed of a variety of other materials, such as metals, and/or can be overmolded, such as with a resilient coating for dampening of the piston 40. As illustrated in FIGS. 2-3, the stem portion 37 of the air inlet 36 can be coupled with a rear backing plate 42 of the linear motor 40, such as through threaded engagement, compression fit, interference fit, or any of a variety of suitable alternative coupling arrangements. The oscillating tool 30 can include a trigger assembly 46 that can be selectively actuated to facilitate operation of the linear motor 40.

The trigger assembly 46 can include a valve spring 48, a valve overmold 50, and a plunger 52. The valve spring 48 can be seated in the stem portion 37 of the air inlet 36, and one end of the valve overmold 50 can be coupled to the valve spring 48. The other end of the valve overmold 50 can be coupled with a finger 54 that contacts the plunger 52. The plunger 52 can be slidably coupled with the rear backing plate 42 and can be biased into a released position (shown in FIGS. 2 and 3) by a spring 56. When the plunger 52 in the released position, the valve overmold 50 can mate with a valve bushing 58 to substantially seal the rear backing plate 42 and prevent pressurized air from passing through to the rest of the linear motor 40. When the plunger 52 is depressed (not shown), the valve overmold 50 is urged away from the valve bushing 58 enough to permit pressurized air to flow through the rear backing plate 42 and operate the piston 44 such that it reciprocates along a longitudinal axis L.

As illustrated in FIG. 2, the oscillating tool 30 can include a trigger handle 60 associated with the plunger 52 and pivotally coupled to the housing 31 of the oscillating tool 30. The trigger handle 60 can be arranged along a bottom of the oscillating tool 30 and can be configured for selective actuation by a user's hand when grasping the oscillating tool 30. When the trigger handle 60 is depressed, the plunger 52 can be depressed to facilitate operation of the linear motor 40. The trigger handle 60 can provide a mechanical advantage for actuating the plunger 52 and can also cooperate with adjacent portions of the housing 31 to substantially conceal the plunger 52 and provide an aesthetically pleasing appearance to the oscillating tool 30.

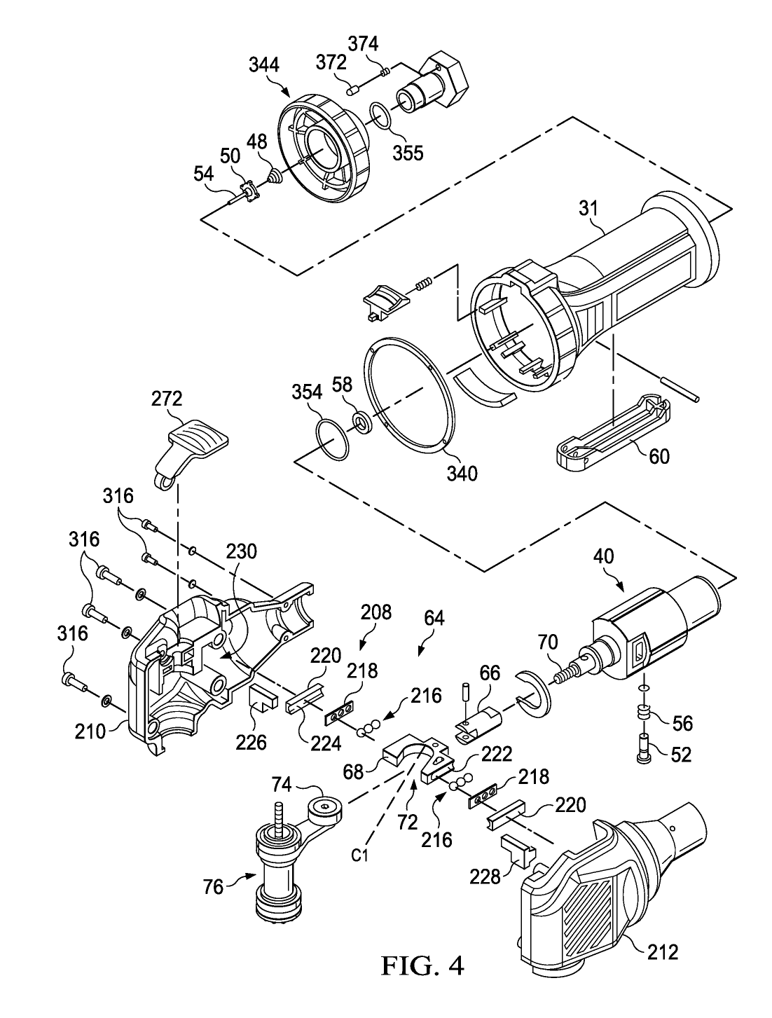

Referring now to FIGS. 2-4, the piston 44 can be coupled with a transmission assembly 64. The transmission assembly 64 can include a cam boss 66 and a cam 68. In one embodiment, the cam boss 66 can be threaded onto a shaft 70 of the piston 44, or in other embodiments, can be coupled with the shaft 70 through welding, or fasteners or provided as a one-piece construction with a shaft of a piston, or any of a variety of other suitable arrangements. As illustrated in FIG. 4, the cam 68 can define a slot 72 that is configured to receive a bearing 74 from a tool free attachment assembly 76. A centerline C1 is shown to bisect the slot 72. The slot 72 can be angled such that the centerline C1 is angled with respect to the longitudinal axis L. In some embodiments, the slot 72 can be angled such that the centerline C1 is angled from the longitudinal axis L1 by greater than about 30 degrees. When the piston 44 reciprocates, the bearing 74 can ride within the slot 72 and can interact with the cam 68 such that the tool free attachment assembly 76 and the accessory blade 38 oscillate together about a pivotal axis A1 (FIG. 2). It will be appreciated that a cam can be configured to receive a bearing of a tool free attachment assembly in any of a variety of suitable alternative arrangements. For example, a cam can be a closed-type cam and the bearing can be disposed within, and completely surrounded by, the cam.

With reference to FIGS. 2, 5, and 6, the linear motor 40 can include a valve backing plate 78, a valve seat 80, a valve chest 82, a cylinder end plate 84, and a piston housing 86. The valve backing plate 78, the valve seat 80, the valve chest 82, and the cylinder end plate 84 are shown in FIGS. 2 and 3 to be sandwiched between the rear backing plate 42 and the piston housing 86. As will be described in further detail below, the rear backing plate 42, the valve backing plate 78, the valve seat 80, the valve chest 82, the cylinder end plate 84, and the piston housing 86 can cooperate together to route pressurized air from the air inlet 36 to the piston 44 to facilitate actuation of the piston 44.

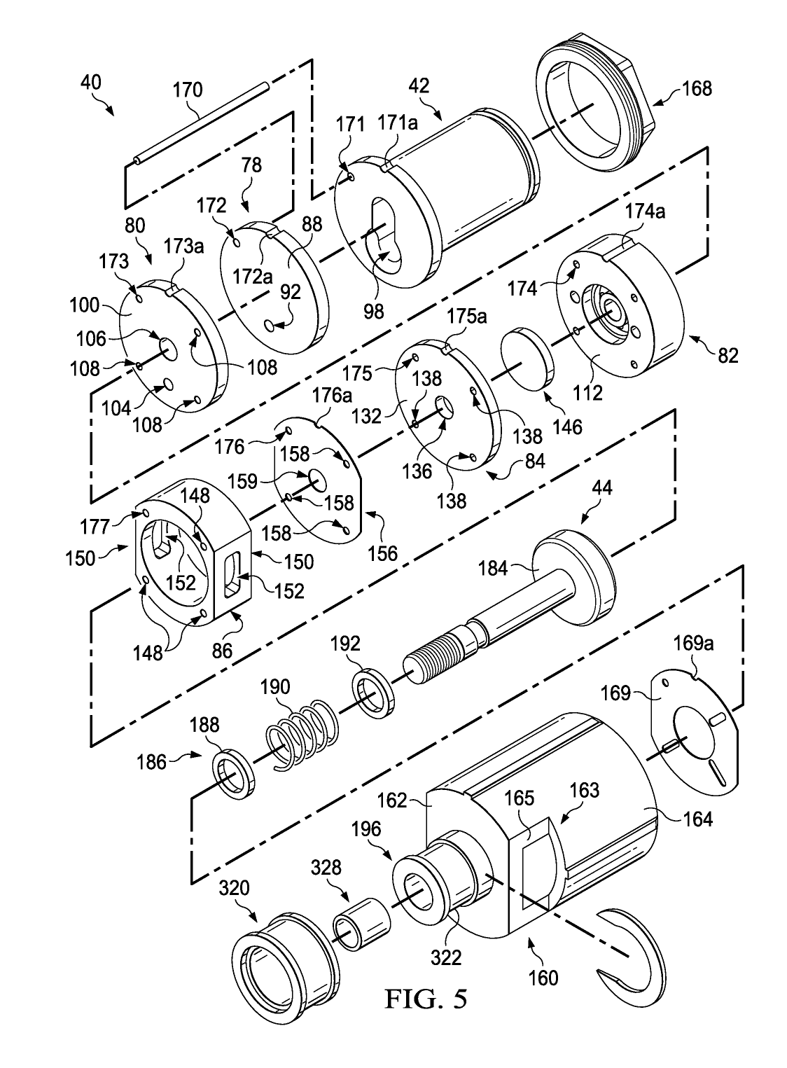

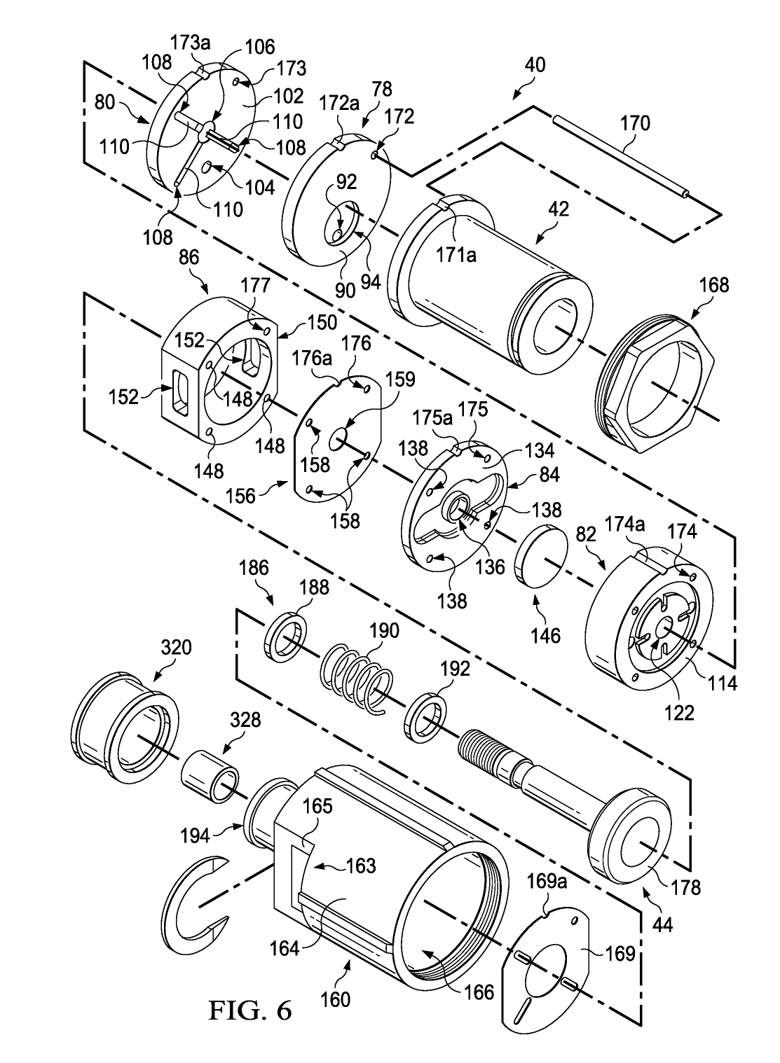

As illustrated in FIGS. 5 and 6, the valve backing plate 78 can include a front surface 88 (FIG. 5) and a rear surface 90 (FIG. 6). The valve backing plate 78 can define a passageway 92. The passageway 92 can extend into a recess 94 defined by the rear surface 90 such that the passageway 92 and the recess 94 are in fluid communication with one another. With the rear backing plate 42 and the valve backing plate 78 sandwiched together, as illustrated in FIGS. 2 and 3, the recess 94 can be in fluid communication with an outlet port 98 defined by the rear backing plate 42. The outlet port 98 is shown in FIG. 5 to have a larger lower opening portion, and the recess 94 can be located such that it registers with the larger lower opening portion of the outlet port 98. The passageway 92 is shown in FIG. 6 to be located along an outer edge of the recess 94 (e.g., substantially tangential to the recess 94) and more proximate to an outer edge of the valve backing plate 78 than to its center. In one embodiment, the passageway 92 and the recess 94 can be sized such that the recess 94 has a diameter that is about four times greater than a diameter of the passageway 92.

The valve seat 80 can include a front surface 100 (FIG. 5) and a rear surface 102 (FIG. 6). The valve seat 80 can define a passageway 104, a central bore 106, and three outer perimeter passageways 108. As illustrated in FIG. 6, each of the three outer perimeter passageways 108 can extend into, and can be in fluid communication with, respective elongated recesses 110 defined by the rear surface 102. Each of the elongated recesses 110 can extend from their respective outer perimeter passageways 108 and to the central bore 106 in a T-shaped arrangement. With the valve backing plate 78 and the valve seat 80 sandwiched together, as illustrated in FIGS. 2 and 3, the passageway 104 of the valve seat 80 can be in fluid communication with the passageway 92 of the valve backing plate 78. The front surface 88 of the valve backing plate 78 can cover the central bore 106, the outer perimeter passageways 108, and the elongated recesses 110.

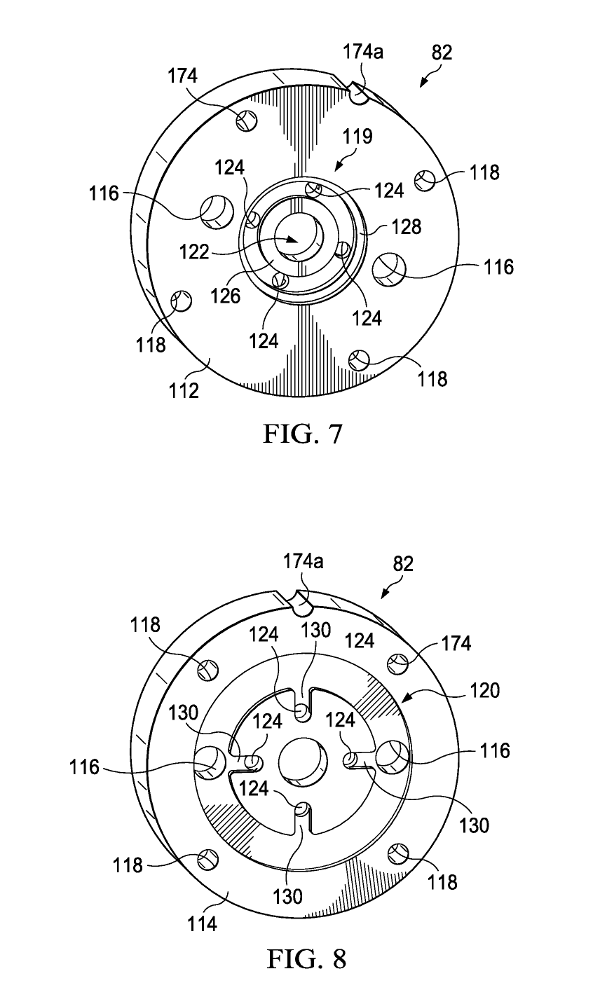

Referring still to FIGS. 5 and 6 and additionally to FIGS. 7 and 8, the valve chest 82 can include a front surface 112 (FIG. 5) and a rear surface 114 (FIG. 6). The valve chest 82 can define a pair of passageways 116 and three outer perimeter passageways 118. The front surface 112 can define a front recess 119. As illustrated in FIGS. 6 and 8, the passageways 116 can extend into a ring recess 120 defined by the rear surface 114. As illustrated in FIG. 7, the valve chest 82 can define a central bore 122 and four inner perimeter passageways 124 that extend into the front recess 119. The inner perimeter passageways 124 can be disposed circumferentially about the central bore 122 and can be spaced from the central bore 122 by an inner shoulder 126. The inner shoulder 126 can be disposed radially inwardly from the inner perimeter passageways 124 and the outer shoulder 128 can be spaced radially outwardly from the inner perimeter passageways 124. As illustrated in FIG. 8, the inner perimeter passageways 124 can extend into, and can be in fluid communication with, respective elongated recesses 130 defined by the rear surface 114. The elongated recesses 130 can extend into, and can be in fluid communication with, the ring recess 120. With the valve seat 80 and the valve chest 82 sandwiched together, as illustrated in FIGS. 2 and 3, each of the outer perimeter passageways 108 of the valve seat 80 can be in fluid communication with respective ones of the respective outer perimeter passageways 118 of the valve chest 82. The passageway 104 of the valve seat 80 can be in fluid communication with the ring recess 120 and thus in fluid communication with the inner perimeter passageways 124. The central bore 106 of the valve seat 80 can be in fluid communication with the central bore 122 of the valve chest 82.

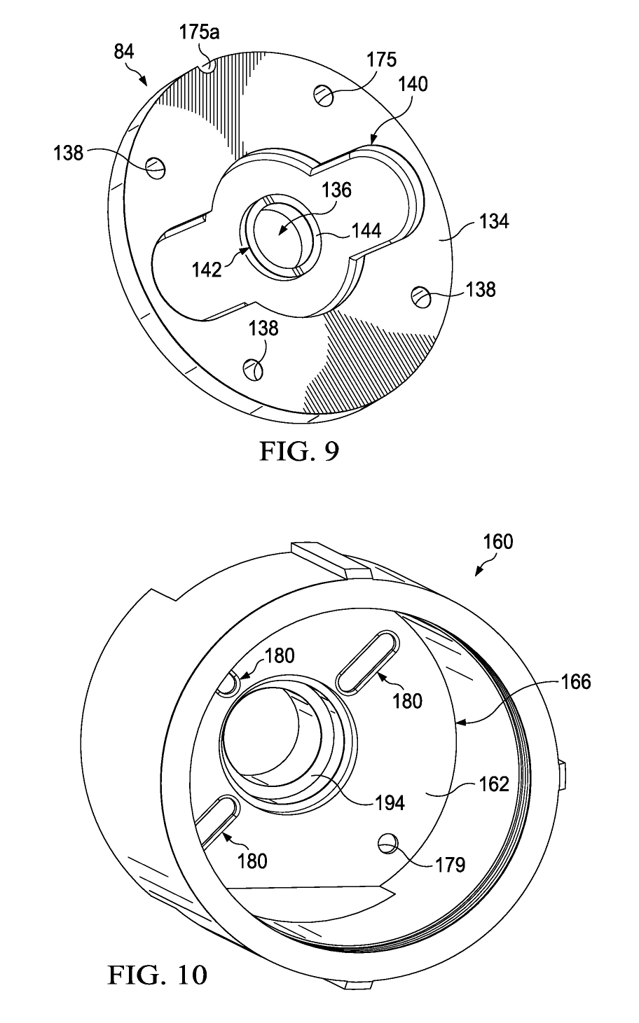

Referring again to FIGS. 5 and 6 and additionally to FIG. 9, the cylinder end plate 84 can include a front surface 132 (FIG. 5) and a rear surface 134 (FIG. 6). The cylinder end plate 84 can define a central bore 136 and three outer perimeter passageways 138. The rear surface 134 of the cylinder end plate 84 can define a recess 140. An inner shoulder 142 can extend from the recess 140 and can define at least part of the central bore 136. The inner shoulder 142 can include an upper surface 144 that is substantially coplanar with the rear surface 134.

As illustrated in FIGS. 5 and 6, a flapper 146 can be provided between the valve chest 82 and the cylinder end plate 84. With the valve chest 82 and the cylinder end plate 84 sandwiched together, as illustrated in FIGS. 2 and 3, the flapper 146 can be disposed within the front recess 119 of the valve chest 82. In addition, each of the outer perimeter passageways 118 of the valve chest 82 can be in fluid communication with respective ones of the outer perimeter passageways 138 of the cylinder end plate 84.

Referring again to FIGS. 5 and 6, the piston housing 86 can define three outer perimeter passageways 148. The piston housing 86 can be formed as a substantially annular ring but with a pair of planar side portions 150. An exhaust port 152 can be defined at each of the planar side portions 150. A gasket 156 can be sandwiched between the cylinder end plate 84 and the piston housing 86 and can define through holes 158 and a central bore 159 that are arranged to permit passage of fluid between the cylinder end plate 84 and the piston housing 86. For example, in this arrangement, each of the outer perimeter passageways 138 of the cylinder end plate 84 can be in fluid communication with respective ones of the outer perimeter passageways 148 of the piston housing 86.

Referring again to FIGS. 5 and 6, the linear motor 40 can include an outer housing 160 having an end wall 162 and a side wall 164 that cooperate to define an interior 166. The outer housing 160 can have a pair of planar side portions 163 that each define an exhaust port 165. Each of the valve backing plate 78, the valve seat 80, the valve chest 82, the cylinder end plate 84, and the piston housing 86 can be disposed within the interior 166 of the outer housing 160, as illustrated in FIGS. 2 and 3, and sandwiched between the end wall 162 and a securing ring 168. A gasket 169 can be sandwiched between the end wall 62 and the piston housing 86. The securing ring 168 can be threaded to the side wall 164 of the outer housing 160 to restrain the valve backing plate 78, the valve seat 80, the valve chest 82, the cylinder end plate 84, and the piston housing 86 within the interior 166 of the outer housing 160. In other embodiments, the securing ring 168 can be secured with a circlip, through frictional engagement, through welding, or any of a variety of suitable alternative securement methods. As illustrated in FIGS. 5 and 6, the linear motor 40 is shown to include an alignment pin 170 which projects through alignment holes 172, 173, 174, 175, 176, 177 of the valve backing plate 78, the valve seat 80, the valve chest 82, the cylinder end plate 84, the gasket 156, and the piston housing 86, respectively to facilitate proper alignment during assembly of the linear motor 40. As illustrated in FIG. 5, the rear backing plate 42 can define an alignment recess 171. As illustrated in FIG. 10, the front wall 162 of the outer housing 160 can define an alignment recess 179. Each of the alignment recesses 171, 179 can receive respective ends of the alignment pin 170 when the linear air motor 40 is assembled. As illustrated in FIGS. 5 and 6, the rear backing plate 42, the valve backing plate 78, the valve seat 80, the valve chest 82, the cylinder end plate 84, the gasket 156, the piston housing 86, and the gasket 169 can define respective alignment notches 171a, 172a, 173a, 174a, 175a, 176a, 177a, 169a that allow for visual alignment of these components prior to installation of the alignment pin 170.

When the trigger assembly 46 is actuated, pressurized air can flow through the valve backing plate 78, the valve seat 80, the valve chest 82, the cylinder end plate 84, and the piston housing 86 in a manner that facilitates reciprocation of the piston 44. For example, when the trigger assembly 46 is actuated with the piston 44 in a rearward position, as illustrated in FIG. 2, pressurized air can flow through the rear backing plate 42, out of the outlet port 98, and to the recess 94 of the valve backing plate 78. The pressurized air can be routed through the passageway 92, through the passageway 104 of the valve seat 80, to the ring recess 120 of the valve chest 82, and to each of the passageways 116 and the inner perimeter passageways 124. The flapper 146 can rest against the inner and outer shoulders 126, 128 (e.g., in a rearward position) of the valve chest 82 to block the pressurized air at the inner perimeter passageways 124. The pressurized air therefore can flow through the passageways 116 to the recess 140 of the cylinder end plate 84, to the front of the flapper 146, through the central bore 136, through the gasket 156, and can act upon a rear surface 178 of the piston 44 to move the piston 44 forwardly.

As the piston 44 moves past the exhaust ports 152, and toward its forward position, the pressurized air can be exhausted through the exhaust ports 152, 165 and into the atmosphere such that the pressurized air no longer acts upon the rear surface 178 of the piston 44. Once the piston 44 reaches its forward position, the pressurized air through the inner perimeter passageways 124 of the valve chest 82 increases with respect to the passageways 116 and urges the flapper 146 forwardly and into contact with the upper surface 144 of the cylinder end plate 84. The pressurized air is no longer permitted to flow through the central bore 136 of the cylinder end plate 84 and instead flows rearwardly through the central bore 122 of the valve chest 84 and through the central bore 106 of the valve seat 82. The pressurized air can then be routed down the elongated recesses 110, through the outer perimeter passageways 108, 118, and 138 of the valve seat 80, the valve chest 82, and the cylinder end plate 84, respectively, through the through holes 158 of the gasket 156 and through the outer perimeter passageways 148 of the piston housing 86. Three elongated recesses 180 defined by an inner front surface 182 of the outer housing 160, as illustrated in FIG. 10, route the pressurized air to a front surface 184 of the piston 44 to move the piston 44 rearwardly. As the piston 44 moves past the exhaust port 152, and toward its rearward position, the pressurized air can be exhausted through the exhaust ports 152, 165 such that the pressurized air no longer acts upon the front surface 184. Once the piston 44 reaches its rearward position, the pressurized air through the passageways 116 of the valve chest 82 increases with respect to the inner perimeter passageways 124 and urges the flapper 146 rearwardly and into contact with each of the inner and outer shoulders 126, 128 thereby urging the piston 44 forwardly. The pressurized air can repeatedly and alternatively act upon the respective front and rear surfaces 184, 178 of the piston 44 to facilitate reciprocation of the piston 44.

It will be appreciated that the use of a flapper-type arrangement in the linear motor 40 can provide for a compact and efficient design. As a result, the pressurized air though the linear motor 40 can undergo a relatively low pressure drop which can enhance the motor's efficiency as well as the throughput of air to the piston 44. Accordingly, a smaller quantity of compressed air can be required for a hand-held pneumatic oscillating tool to accomplish a particular task, as compared with conventional hand-held pneumatic oscillating tools that incorporate a rotary vane-type motor. Reducing the required quantity of compressed air can allow for use of a smaller and less powerful air compressor, and can provide energy and cost savings. In addition, the compact size of the linear motor 40 can enhance the overall size and weight of a hand-held pneumatic oscillating tool thus making it easy to handle and store. It will also be appreciated, that although a particular type of linear motor is described herein, namely a flapper-type motor, any of a variety of other suitable types of linear motors having a pneumatically-operated linear piston can alternatively be provided to achieve various design objectives.

Referring again to FIGS. 2-3 and 5-6, the linear motor 40 can include a return spring assembly 186 that is configured to bias the piston 44 to the rearward position. The return spring assembly 186 can include a front washer 188, a spring 190, and a rear washer 192. The front washer 188, the spring 190, and the rear washer 192 can be circumferentially disposed about the shaft 70 of the piston 44 which is shown to extend from the front surface 184 of the piston 44. The front washer 188 can abut an interior front shoulder 194 defined by a front collar 196 of the outer housing 160. The rear washer 192 can abut the front surface 184 of the piston 44. The spring 190 can be sandwiched between the front and rear washers 188, 192 and can bias the piston 44 into the rearward position. In one embodiment, the front washer 188, the spring 190, and the rear washer 192 can be formed of steel or other alloy. In such an embodiment, the interior front shoulder 194 and the front surface 184 of the piston 44 can be less susceptible to wear from the front and rear washers 188, 192 than some conventional, non-steel, washer arrangements. In other embodiments, the front and rear washers 188, 192 and/or spring 190 might be formed of any of a variety of suitable alternative materials.

The return spring assembly 186 can urge the piston 44 into the rearward position once the linear motor 40 has ceased operation. The bias provided by the spring 190 might not be significant enough to aid significantly in the reciprocation of the piston 44 during operation of the linear motor 40. However, when the linear motor 40 ceases operation (e.g., when the operator releases the trigger handle 60), the force provided by the spring 190 can be substantial enough to return the piston 44 to the rearward position. Accordingly, the piston 44 can be returned to the rearward position when the linear motor 40 ceases operation, which can allow for more efficient and effective startup of the linear motor 40 than if the piston 44 were permitted to remain in any position when pressurized air is removed. For example, if the linear motor 40 were started without the piston 44 in the rearward position, the pressurized air may not be routed properly through the linear motor 40 and the piston 44 might not receive enough pressurized air to move the piston 44 in either direction.

The return spring assembly 186 is shown in FIGS. 2 and 3 to be disposed entirely within the interior 166 of the outer housing 160. In this arrangement, the return spring assembly 186 can be protected from certain environmental conditions external to the linear motor 40 such as moisture or dust particles, for example. In addition, the return spring assembly 186 can remain contained within the interior 166 during assembly of the linear motor 40 which can promote effective and efficient installation of the linear motor 40.

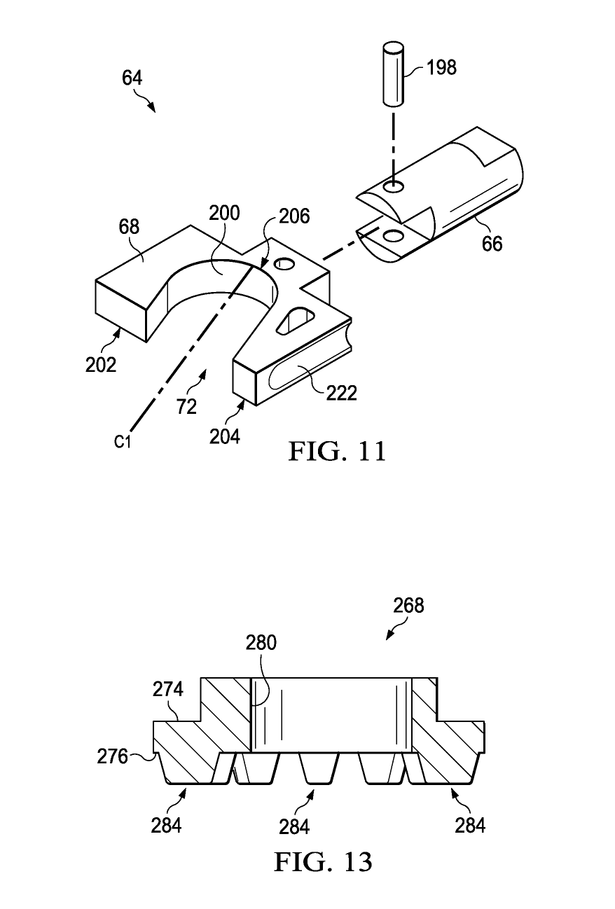

Referring again to FIG. 4, and additionally to FIG. 11, the operation of the transmission assembly 64 in conjunction with the tool free attachment assembly 76 will now be described. As illustrated in FIG. 11, the cam boss 66 and the cam 68 can be pivotally coupled together by a pin 198. In one embodiment, the pin 198 can be press fit into the cam boss 66. When the piston 44 reciprocates and the bearing 74 rides (e.g., slides) within the slot 72, the cam 68 can pivot slightly with respect to the cam boss 66 about the pin 198. Permitting the cam 68 to pivot in this manner during operation of the linear motor 40 can accommodate for any variation in the tolerances between the parts and/or other inconsistencies between the slot 72 and the bearing 74. Pivoting of the cam 68 can also reduce the susceptibility of the bearing 74 becoming bound within the slot 72.

The slot 72 is shown to be substantially u-shaped and defined by an inner surface 200 of the cam 68. The slot 72 can be angled towards one side of the cam 68 such that a right end portion 202 of the cam 68 is wider than a left end portion 204. When the piston 44 reciprocates and operates the transmission assembly 64, the shape and orientation of the slot 72 can facilitate pivoting of the tool free attachment assembly 76 about the pivotal axis A1. For example, when the piston 44 moves forwardly, the bearing 74 can ride along the left end portion 204 of the cam 68, such that the tool free attachment assembly 76 pivots counterclockwise (when viewing the oscillating tool 30 from above). When the piston 44 reaches its forward position, the bearing 74 can be cradled within a backstop portion 206 of the slot 72. When the piston 44 moves rearwardly, the bearing 74 can ride long the right end portion 202 of the cam 68, such that the tool free attachment assembly 76 pivots clockwise. The cam 68 can repeatedly and alternatively act upon the bearing 74 in this manner to facilitate oscillation of the tool free attachment assembly 76 about the pivotal axis A1.

As illustrated in FIG. 4, the cam 68 can be supported by, and sandwiched between, a pair of linear bearing assemblies 208. Each of the linear bearing assemblies 208 can be interposed between the cam 68 and respective right and left portions 210, 212 of a head assembly 214. Each of the bearing assemblies 208 can include a plurality of bearing balls 216, a race 218, and a slotted retainer 220. The bearing balls 216 can ride within respective grooves (e.g., 222 shown in FIGS. 4 and 11) of the cam 68 as well as within grooves (e.g., 224) of the slotted retainer 220. When the transmission assembly 64 is actuated by the linear motor 40, the linear bearing assemblies 208 can facilitate journalled movement of the cam 68 with respect to the head assembly 214. Although the bearing assemblies 208 are shown to include three bearing balls 216, it will be appreciated that bearing assemblies with less than three bearing balls or greater than three bearing balls can be provided.

The oscillating tool 30 can include at least one resilient member provided adjacent to the transmission assembly 64 and configured to dampen forward movement of the piston 44 and/or portions of the transmission assembly 64. In one embodiment, as illustrated in FIGS. 2-4, the resilient member can comprise a pair of bumper members 226, 228 that are disposed forwardly of the cam 68 and adjacent the right and left portions 202, 204 of the cam 68, respectively. The right and left portions 210, 212 of the head assembly 214 can cooperate to define a head compartment 229 and the bumper members 226, 228 can be disposed within the head compartment 229. Each of the right and left portions 210, 212 of the head assembly 214 can define a receptacle (e.g., 230 shown in FIGS. 2-4) that is shaped similarly to the bumper members 226, 228 and arranged to support the bumper members 226, 228 forwardly of the cam 68.

When the linear motor 40 operates, the right and left portions 202, 204 of the cam 86 can selectively contact the respective bumper members 226, 228 to prevent further forward motion of the piston 44. For example, as the piston 44 approaches its extended position, the cam 68 can remain spaced from the pair of bumper members 226, 228, as illustrated in FIG. 2. As the piston 44 approaches its forwardmost position, the cam 68 can contact the bumper members 226, 228. The bumper members 226, 228 can absorb the impact of the cam 68 to assist in stopping the forward movement of the piston 44. Once the piston 44 has stopped, the flapper 146 can change positions, as described above, and the pressurized air can cause the piston 44 to move rearwardly. It will be appreciated that although the transmission assembly 64 is shown to be disposed entirely within the head compartment 229, a transmission assembly can be additionally or alternatively disposed in a motor compartment in a manner that still permits contact with bumper members.

The bumper members 226, 228 can be formed of an elastic material that provides sufficient cushioning to slow the forward movement of the cam 68 as the piston 44 reaches its forward position and without contacting adjacent portions of the head assembly 214. In one embodiment, the bumper members 226, 228 can be formed of a fluoroelastomer having a durometer value of between about 65 and about 85.

It will be appreciated that slowing the forward movement of the piston 44 can enhance the overall operation of the linear motor 40. For example, with portions of the transmission assembly 64 secured to the shaft 70 of the piston 44, the mass of the linear motor 40 can be unevenly distributed towards the front of the linear motor 40. As the piston 44 moves forwardly, the uneven distribution of mass can become more severe. By the time the piston 44 reaches its forward position, the imbalanced distribution of mass can become so significant that the inertia of the cam 68 might, were it not for the bumper members 226, 228, cause the piston 44 to impact the gasket 169 or the end wall 162 resulting in excessive and uncontrolled vibration to the oscillating tool 30 and/or damage.

It will be appreciated that any of a variety of resilient member configurations can be provided to facilitate dampening of movement of a piston and/or portions of a transmission assembly. In one example, a resilient member can comprise a spring that selectively interacts with a cam boss. In another example, the resilient member can be a hydraulic arrangement configured to interact with a portion of a piston shaft.

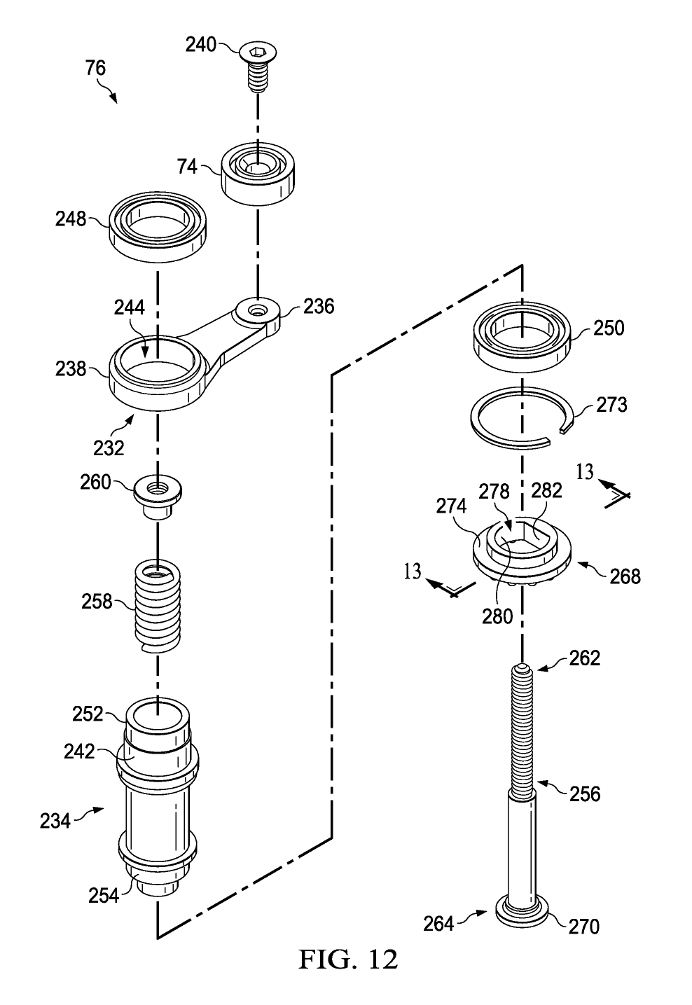

Referring again to FIG. 4, and additionally to FIG. 12, the operation of the tool free attachment assembly 76 will now be described. The tool free attachment assembly 76 can be at least partially disposed within the head compartment 229. The tool free attachment assembly 76 can include an arm member 232 and a sleeve 234. The arm member 232 can include a bearing support portion 236 that extends from a central portion 238. The bearing support portion 236 can rotatably support the bearing 74. The bearing 74 is shown to be releasably secured to the bearing support portion with a screw 240, but, in other arrangements, a bearing can be coupled to an arm member with any of a variety of suitable alternative coupling arrangements. The sleeve 234 can include a first upper collar 242 and the central portion 238 of the arm member 232 can define an opening 244. The central portion 238 of the arm member 232 can fit over the sleeve 234 and into frictional engagement with the first upper collar 242. The opening 244 is shown to be substantially round. However, in an alternative embodiment, an opening of an arm member can define a flat portion (not shown) that can register with a corresponding flat portion (not shown) on a sleeve to ensure proper alignment and pivotal coupling of the arm member and the sleeve together. In an alternative embodiment, a sleeve and arm member can be coupled in an alternative configuration, or provided as a one-piece construction.

The tool free attachment assembly 76 can also include upper and lower bearings 248, 250 that journal the sleeve 234 with respect to the head assembly 214. The upper and lower bearings 248, 250 can be respectively provided at opposite ends of the sleeve 234. The upper and lower bearings 248, 250 can be press fit or otherwise frictionally engaged with a second upper collar 252 and a lower collar 254, respectively. The second upper collar 252 can have a smaller diameter than the first upper collar 242, as shown in FIG. 12.

The tool free attachment assembly 76 can further include a plunger 256, a spring 258, and a cap 260. The plunger 256 can include an upper end 262 and a lower end 264 and can be partially disposed within the sleeve 234 with the upper and lower ends 262, 264 extending beyond the sleeve 234. The spring 258 can be disposed within the sleeve 234 and sandwiched between the sleeve 234 and the cap 260. The cap 260 can be threaded onto the upper end 262 of the plunger 256 to retain the spring 258 in place. An accessory disk 268 (e.g., arbor) can be sandwiched between the sleeve 234 and a flange portion 270 at the lower end 264 of the plunger 256. An internal circular retaining ring 273 can be sandwiched between the lower bearing 250 and the accessory disk 268 and can facilitate selective securement of the lower bearing 250 to the sleeve 234. The accessory disk 268 can be configured to engage or release an accessory (e.g., the accessory blade 38 shown in FIGS. 1-4) depending upon whether the plunger 256 is in a released position (e.g., clamping position) or a depressed position. It will be appreciated that the position of the cap 260 on the plunger 256 can be adjusted to change the preloading of the spring 258 and thus the clamping force of the tool free attachment assembly 76.

The spring 258 can bias the plunger 256 upwardly (e.g., into a clamping position) which can facilitate selective retention of the accessory blade 38 between the accessory disk 268 and the flange portion 270 of the plunger 256. For example, as illustrated in FIGS. 2 and 3, the spring 258 can bias the plunger 256 upwardly which can result in the flange portion 270 being pulled upwardly with respect to the sleeve 234 and applying a clamping force to the accessory blade 38. When the plunger 256 is depressed, the spring 258 can be compressed and the flange portion 270 can move away from the accessory disk 268 to release the clamping force and permit removal of the accessory blade 38 from the tool free attachment assembly 76. The installation/removal of the accessory blade 38 can accordingly be accomplished without requiring the removal of components as is typical in some conventional tool arrangements (e.g., detachment of an accessory disk by removing a screw).

As illustrated in FIGS. 1-4, the oscillating tool 30 can further include an accessory release handle 272 that overlies the plunger 256 and is pivotally coupled with the head assembly 214. The accessory release handle 272 can be depressed by a user to depress the plunger 256 for removal or installation of an accessory blade. The accessory release handle 272 can provide a mechanical advantage for actuating the plunger 256 and can also cooperate with adjacent portions of the head assembly 214 to substantially conceal the plunger 256 and provide an aesthetically pleasing look to the oscillating tool 30. It will be appreciated that a plunger can additionally or alternatively be actuated directly by a hand of a user, or through a user's operation of a pushbutton, a servo, or any of a variety of other suitable alternative devices.

As illustrated in FIGS. 12-14, the accessory disk 268 is shown to include an upper surface 274 and a lower surface 276. The accessory disk 268 is shown to include an inner edge 280 that includes a flat portion 282 and defines a central aperture 278. When the accessory disk 268 is attached to the plunger 256, the flat portion 282 can register with a flat portion (not shown) on the sleeve 234 to prevent rotation of the accessory disk 268 relative to the sleeve 234. A plurality of ovular protrusions (e.g., 284) can extend from the lower surface 276 (or can otherwise be defined by the lower surface 276) and can be disposed circumferentially about the inner edge 280. The ovular protrusions (e.g., 284) can be spaced substantially evenly from one another and can, in one embodiment, be spaced substantially evenly between the inner edge 280 and an outer edge 286.

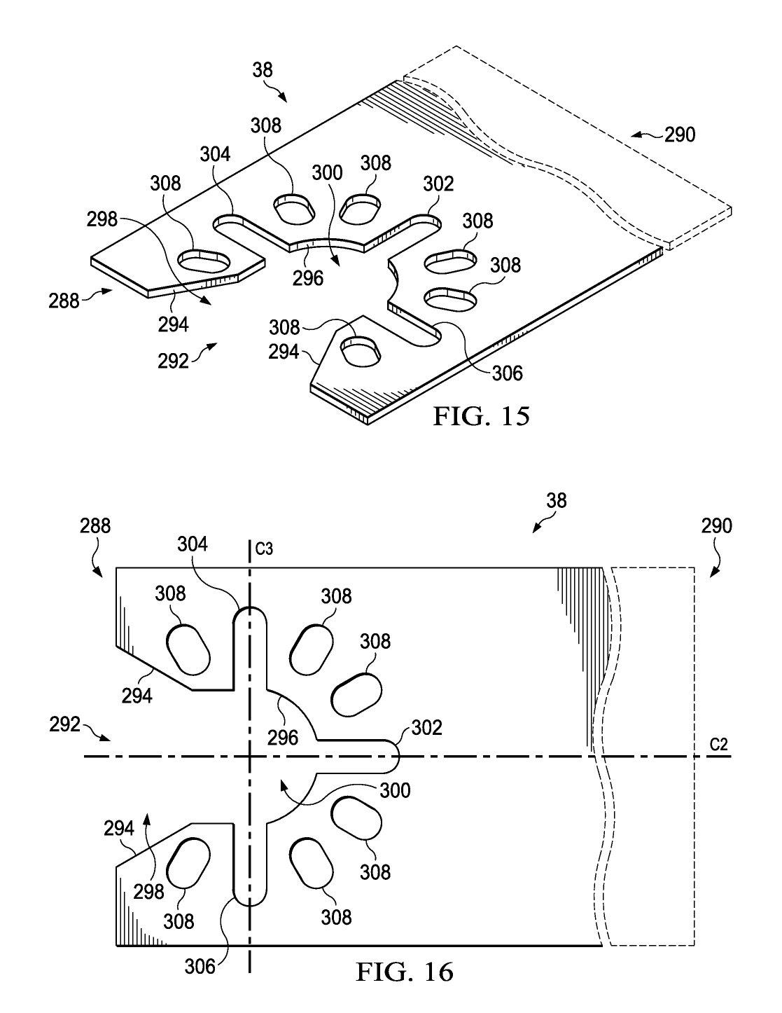

The accessory blade 38 is further illustrated in FIGS. 15 and 16 and can be configured for use with the accessory disk 268. The accessory blade 38 can extend between a shank end 288 and a working end 290. In one embodiment, the working end 290 can comprise a saw tooth edge, but in other embodiments, the working end 290 can be configured to accomplish any of a variety of tasks such as cutting, polishing, grinding, or the like. The shank end 288 can be selectively clamped between the flange portion 270 of the plunger 256 and the accessory disk 268 to secure the accessory blade 38 to the tool free attachment assembly 76. More particularly, the shank end 288 of the accessory blade 38 can define a main opening 292 having a pair of angled edges 294 that respectively terminate at a generally U-shaped edge 296. The angled edges 294 can define a generally V-shaped entryway 298 of the main opening 292 and the generally U-shaped edge 296 can define a generally U-shaped backstop 300 of the main opening 292. The configuration of the angled edges 294 can narrow the main opening 292 into the generally U-shaped backstop 300. When the shank end 288 of the accessory blade 38 is installed between the flange portion 270 of the plunger 256 and the accessory disk 268, the generally V-shaped entryway 298 can accommodate for some initial misalignment between the plunger 268 and the generally U-shaped backstop 300, and the angled edges 294 can facilitate guidance of the plunger 268 into a fully installed position (e.g., with the plunger 268 received in the generally U-shaped backstop 300), thereby easing the installation process.

Still referring to FIGS. 15-16, the shank end 288 can define a first slot 302, a second slot 304, a third slot 306 and a plurality of apertures 308. The first, second, and third slots 302, 304, 306 can be in communication with the main opening 292. A longitudinal centerline C2 (FIG. 16) can extend longitudinally between the shank end 288 and the working end 290. A lateral centerline C3 (FIG. 16) can be substantially perpendicular to the longitudinal centerline C2 and can extend laterally across the generally U-shaped backstop 300. The first, second, and third slots 302, 304, 306 can be distributed about a circumference of the main opening 292 such that they are provided in a substantially T-shaped arrangement. The first slot 302 can be bisected by the longitudinal centerline C2 and the second and third slots 304, 306 can be bisected by the lateral centerline C3. Two of the apertures 308 can be distributed between the first slot 302 and the second slot 304, two of the apertures 308 can be distributed between the first slot 302 and the third slot 306, one of the apertures 308 can be disposed between one of the angled edges 294 and the second slot 304, and one of the apertures 308 can be disposed between the other of the angled edges 294 and the third slot 306. The shank end 288 is shown to have three slots (i.e., 302, 304, 306) and six apertures (i.e., 308), but it will be appreciated that a shank end of an accessory blade can have more or less than three slots and/or more or less than six apertures. It will also be appreciated that the configuration of the accessory blade 38 allows it to be used on any of a variety of oscillating tools including those oscillating tools that are identified as being only suitable for use with a particular manufacturer's blades.

When the shank end 288 is clamped between the flange portion 270 of the plunger 256 and the accessory disk 268, respective ones of the ovular protrusions 284 can extend through the first, second, and third slots 302, 304, 306 and the apertures 308 to secure the shank end 288 and prevent the accessory blade 38 from inadvertently rotating during operation of the linear motor 40. With the first, second, and third slots 302, 304, 306 and the apertures 308 being distributed substantially evenly around the main opening 292, it will be appreciated that the accessory blade 38 can be clamped into any of a plurality of available radial positions upon the accessory disk 268, which it will be appreciated can result in the accessory blade being indexed to predetermined angles to achieve cutting or other tool use at different angles, while keeping a user's hand(s) ergonomically positioned.

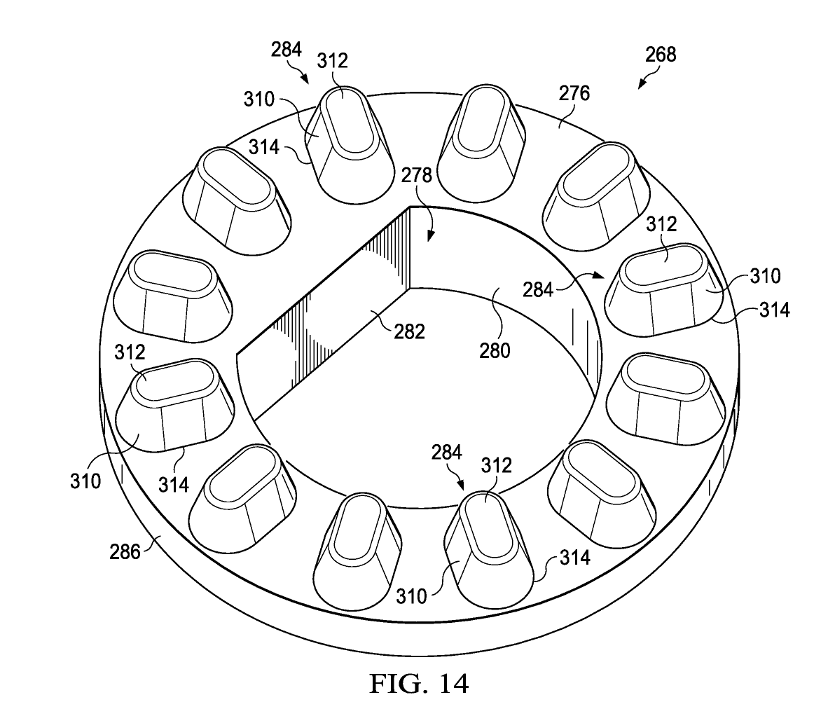

As illustrated in FIGS. 13 and 14, each of the ovular protrusions 284 can be substantially frustoconically shaped. In particular, each of the ovular protrusions 284 can include a respective tapered sidewall 310. Each of the tapered sidewalls 310 can extend from a respective end surface 312 to the lower surface 276 of the accessory disk 268. The interaction between the tapered sidewalls 310 and the lower surface 276 can define respective lower perimeters 314 for the ovular protrusions 284. The tapered sidewalls 310 can be angled such that each respective end surface 312 defines an upper perimeter that is substantially the same shape as the respective lower perimeter 314 but is smaller than the respective lower perimeter 314.

Referring again to FIGS. 15 and 16, the apertures 308 of the accessory blade 38 can have respective perimeters that are of similar shape, but of greater size than the lower perimeters 314 of the ovular protrusions 284, but of less size than the upper perimeters of the ovular protrusions 284. As such, when the accessory disk 268 is clamped between the flange portion 270 of the plunger 256 and the accessory disk 268, the accessory blade 38 can be seated onto the tapered sidewalls 310 of the ovular protrusions 284 and can remain spaced from the lower surface 276 such that the accessory disk 268 is held securely in place. The clamping force necessary to hold the accessory blade 38 in place might be significantly less than the clamping force necessary for securing an accessory blade with a conventional arbor. As such, the spring 258 of the tool free attachment assembly 76 might not need to impart as much force to the accessory disk 268 and thus be formed using lightweight materials.

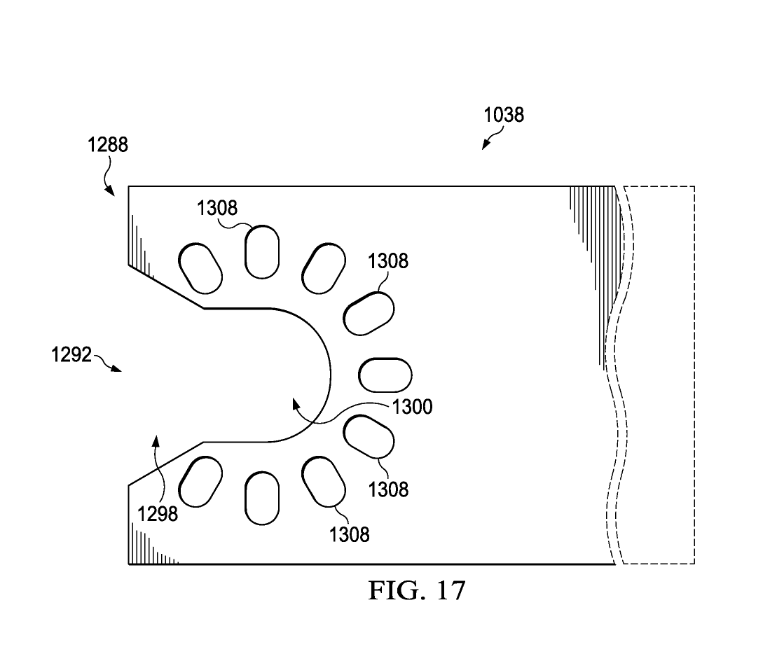

FIG. 17 illustrates an accessory blade 1038 according to another embodiment. The accessory blade 1038 can be, in many respects, similar to or the same as the accessory blade 38 shown in FIGS. 14-16. For example, a shank end 1288 of the accessory blade 1038 can define a main opening 1292 having a generally V-shaped entryway 1298 and a generally U-shaped backstop 1300. However, the shank end 1288 can define a plurality of apertures (e.g., 1308) and can be devoid of any slots (i.e., 302, 304, 306). The plurality of apertures (e.g., 1308) can be distributed substantially evenly about a circumference of the main opening 1292.

It will be appreciated that the overall configuration of the accessory disk 268, and more particularly, the pattern of the ovular protrusions 284, can in one embodiment, be only capable of mating with one or more specific patterns as provided by the accessory blades 38, 1038, thus preventing installation and use of other accessory blades (e.g., blades from other tool manufacturers) with the hand-held pneumatic oscillating tool. However, it will be appreciated that other accessory disk arrangements are contemplated that would permit acceptance and installation of different oscillating tool blades from a variety of oscillating tool manufacturers including those oscillating tool blades that are identified as being only suitable for use with a particular manufacturer's oscillating tool design.

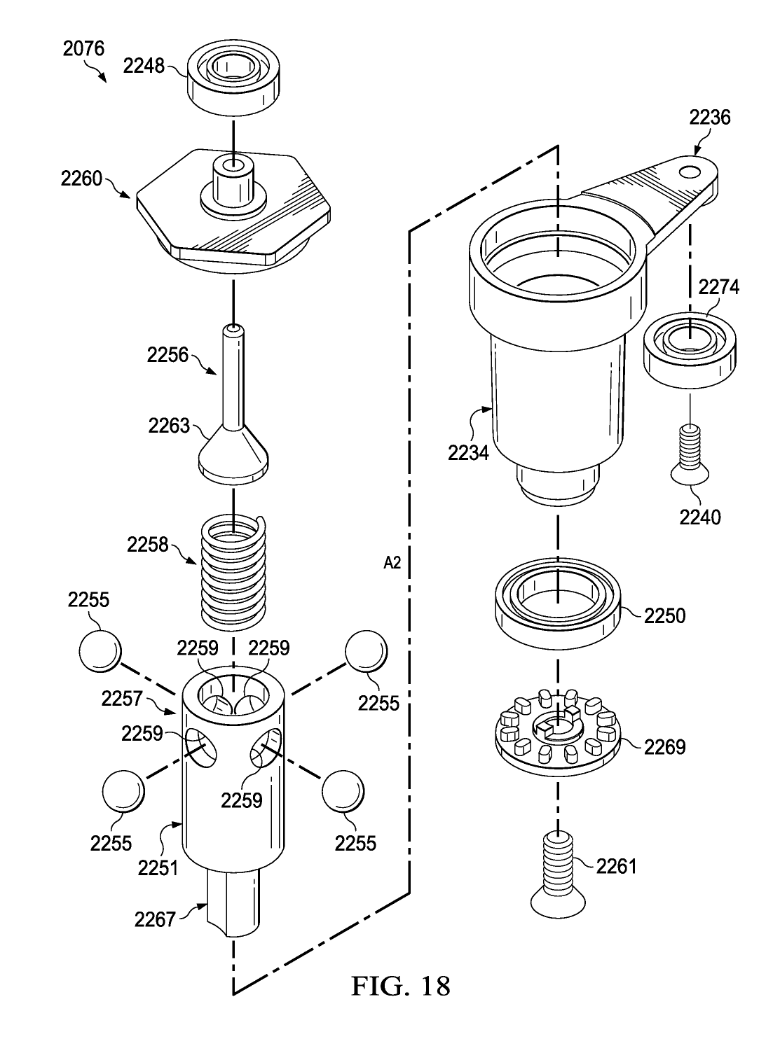

FIG. 18 illustrates a tool free attachment assembly 2076 according to another embodiment. The tool free attachment assembly 2076 can be similar to, or the same in many respects as, the tool free attachment assembly 76 shown in FIGS. 1-4 and 12-13. For example, the tool free attachment assembly 2076 can include a sleeve 2234, an arm 2236 (e.g., bearing support portion), an upper bearing 2248, a lower bearing 2250, a plunger 2256, a spring 2258, and a cap 2260. However, the tool free attachment assembly 2076 can include a spindle 2251, balls 2255 and an accessory disk 2269. The sleeve 2234 can be formed together with the arm 2236 as a one-piece construction such that the arm 2236 is disposed at an upper end of the sleeve 2234. Alternatively, the sleeve 2234 can be coupled with the arm 2236 in a variety of different arrangements. The spindle 2251 can be disposed within the sleeve 2234 and can support the spring 2258. The balls 2255 can be interposed between the spindle 2251 and the sleeve 2234 and can be disposed at least partially within a plurality of holes 2259 defined by the spindle 2251. The holes 2259 can be spaced circumferentially about an upper portion of the spindle 2251 and can cooperate to define a groove (e.g., 2257). The balls 2255 can be associated with respective ones of the holes 2259. The spring 2258 can provide underlying support for the plunger 2256 and an upper end of the plunger 2256 can extend through the cap 2260 such that a portion of the plunger 2256 is sandwiched between the spring 2258 and the cap 2260. The accessory disk 2269 can be coupled to the spindle 2251 with a screw 2261. An accessory (not shown), such as an accessory blade or sanding disc for example, can be selectively and removably interposed between the sleeve 2234 and the accessory disk 2269.

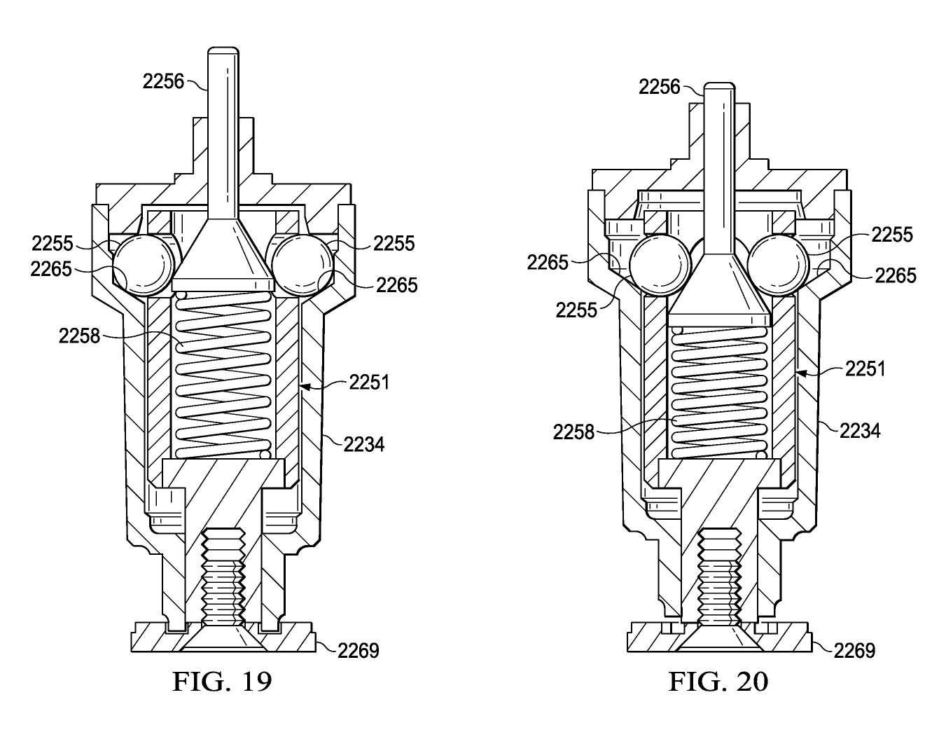

The plunger 2256 can have a frustoconical portion that defines an outer angled surface 2263. The sleeve 2234 can define an inner angled surface 2265 (FIG. 19). The balls 2255 can be interposed between the outer angled surface 2263 and the inner angled surface 2265. The spring 2258 can bias the plunger 2256 upwardly, such that the outer angled surface 2263 of the plunger 2256 forces the balls 2255 outwardly and against the inner angled surface 2265. The spindle 2251 can accordingly be biased upwardly which can facilitate selective retention of an accessory (not shown) between the sleeve 2234 and the accessory disk 2269. In one embodiment, the groove 2257, the spindle 2251 and the sleeve 2234 can cooperate to permit the balls 2255 to only move perpendicularly to (as opposed to along) a pivotal axis A2 of the sleeve 2234.

A bearing 2274 can be coupled with the arm 2236 by a screw 2240. The upper bearing 2248 and the lower bearing 2250 can be supported by the cap 2260 and a lower portion of the sleeve 2234, respectively. The spindle 2251 can include a stem portion 2267 that can extend into the sleeve 2234 and can define a threaded aperture (not shown). The screw 2261 can be threaded into the threaded aperture of the stem portion 2267 to facilitate releasable coupling of the accessory disk 2269 to the spindle 2251.

The plunger 2256 can be selectively depressed by a user of the tool to release the accessory from between the sleeve 2234 and the accessory disk 2269. Depressing the plunger 2256 can compress the spring 2258, which can allow the balls 2255 to move towards each other (e.g., recede into the spindle 2251), and the spindle 2251 to lower to release an accessory from between the sleeve 2234 and the accessory disk 2269. It will be appreciated that the plunger 2256 can be actuated directly by a hand of a user, or through a user's operation of a lever, a pushbutton, a servo, or any of a variety of other suitable alternative devices. It will be appreciated that any of a variety of alternative tool free attachment assemblies can be provided that facilitate selective retention of an accessory. Other accessory attachment mechanisms are contemplated such as those that might require use of a separate tool (e.g., an allen wrench) to facilitate selective retention of an accessory.

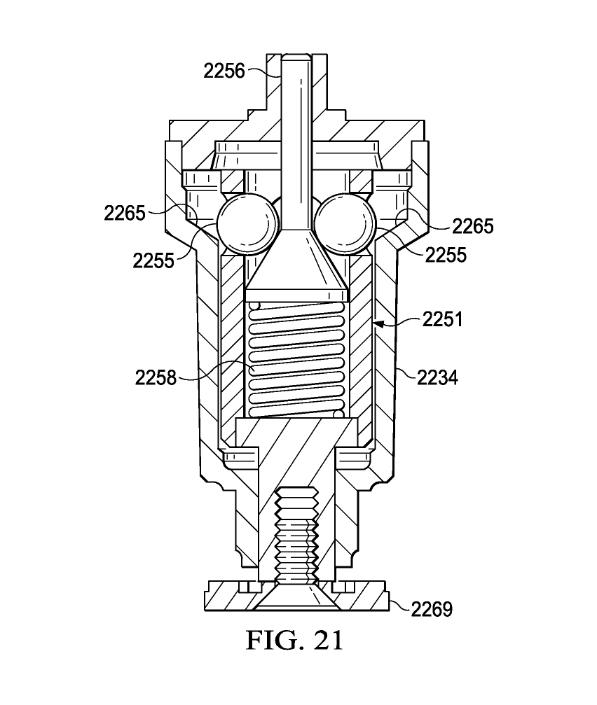

Additional details of the actuation of the plunger 2256 can be appreciated from FIGS. 19-21. When the plunger 2256 is in a released (e.g., clamping) position, as illustrated in FIG. 19, the spring 2258 can bias the plunger 2256 upwardly which pushes the balls 2255 outwardly against the respective angled surfaces 2263, 2265. The spindle 2251 can accordingly be pulled upwardly with respect to the sleeve 2234, which can apply a clamping force between the sleeve 2234 and the accessory disk 2269. Depressing the plunger 2256, as illustrated in FIG. 20, results in the plunger 2256 beginning to move into the spindle 2251 and compression of the spring 2258, such that the balls 2255 begin to retract into the holes 2259, and the accessory disk 2269 begins to separate from the sleeve 2234. As the plunger 2256 continues to be depressed, the plunger 2256 can move further into the spindle 2251, the balls 2255 can retract further into the holes 2259, and the accessory disk 2269 can become further spaced from the sleeve 2234. Once the plunger 2256 is fully depressed, as illustrated in FIG. 21, the accessory disk 2269 is spaced from the sleeve 2234 sufficiently enough to allow an accessory blade (e.g., 38 shown in FIGS. 1-4 and 15-16) to be removed or installed. Spacing the accessory disk 2269 from the sleeve 2234 in this manner can avoid the need to completely detach an accessory disk, such as by removing a screw threaded into a spindle, to remove/install an accessory blade as is typical in some conventional tool arrangements.

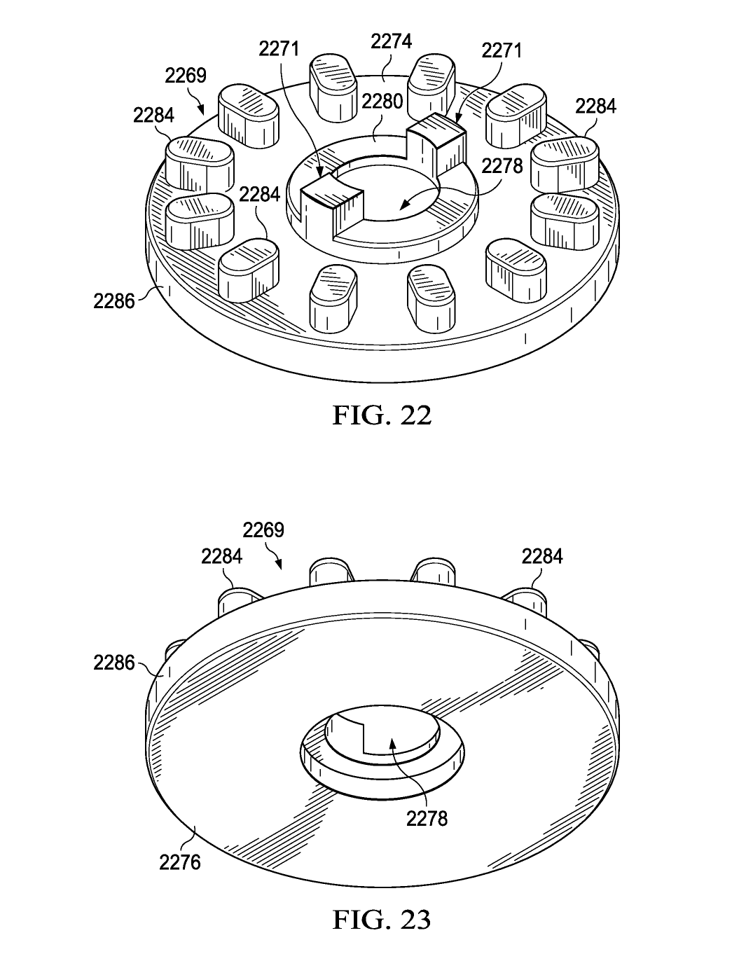

The accessory disk 2269 is shown in FIGS. 22-27. The accessory disk 2269 can include an upper surface 2274 and a lower surface 2276. The accessory disk 2269 can also include a central ring 2280 that defines a central aperture 2278. A pair of fingers 2271 can extend upwardly from the central ring 2280. When the accessory disk 2269 is attached to the spindle 2251 (e.g., with the screw 2261), the fingers 2271 can interact with the spindle 2251 to prevent rotation of the accessory disk 2269 relative to the spindle 2251. A plurality of ovular protrusions (e.g., 2284) can extend upwardly from the upper surface 2274 (or can otherwise be defined by the upper surface 2274) and can be disposed circumferentially about the central ring 2280, as shown in FIG. 22, for example. The ovular protrusions 2284 can be spaced substantially evenly from one another and can, in one embodiment, be located more proximate an outer edge 2286 than the central ring 2280. The lower surface 2276 is shown in FIG. 23 to be substantially planar. It will be appreciated that an accessory disk can be provided in any of a variety of suitable alternative configurations.

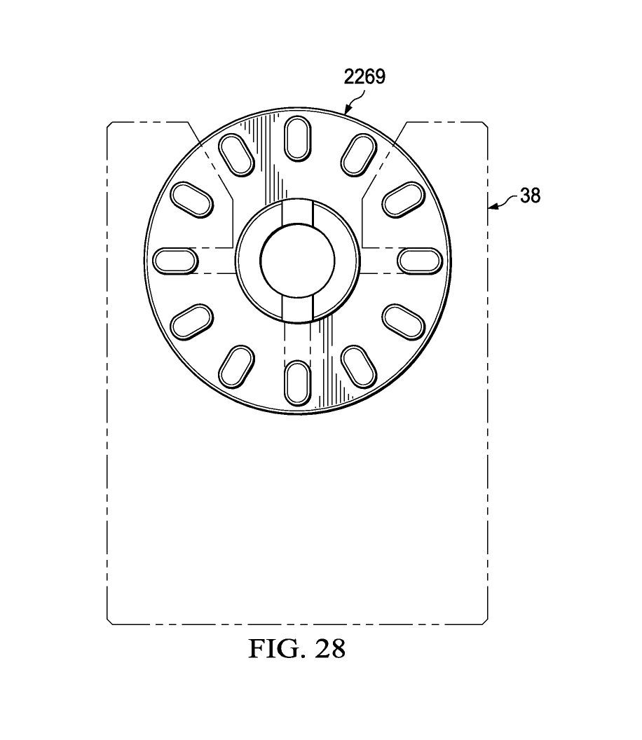

The accessory blade 38 is shown in FIGS. 28-30 to be engaged with the accessory disk 2269. When the shank end 288 is clamped between the sleeve 2234 and the accessory disk 2269, respective ones of the ovular protrusions 2284 can extend through the first, second, and third slots 302, 304, 306 and the apertures 308 to secure the shank end 288 and prevent the accessory blade 38 from inadvertently rotating during operation of the linear motor 40. With the first, second, and third slots 302, 304, 306 and the apertures 308 being distributed substantially evenly around the main opening 292, it will be appreciated that the accessory blade 38 can be clamped into any of a plurality of available radial positions upon the accessory disk 2269, which it will be appreciated can result in the accessory blade being indexed to predetermined angles to achieve cutting or other tool use at different angles, while keeping a user's hand(s) ergonomically positioned.

It will be appreciated that the overall configuration of the accessory disk 268, and more particularly, the pattern of the ovular protrusions 2284, might only be capable of mating with the accessory blades 38, 1038 thus preventing installation and use of other accessory blades (e.g., blades from other tool manufacturers) with the hand-held pneumatic oscillating tool. However, it will be appreciated that other accessory disk arrangements are contemplated that would permit acceptance and installation of different oscillating tool blades from a variety of oscillating tool manufacturers including those oscillating tool blades that are identified as being only suitable for use with a particular manufacturer's oscillating tool design.

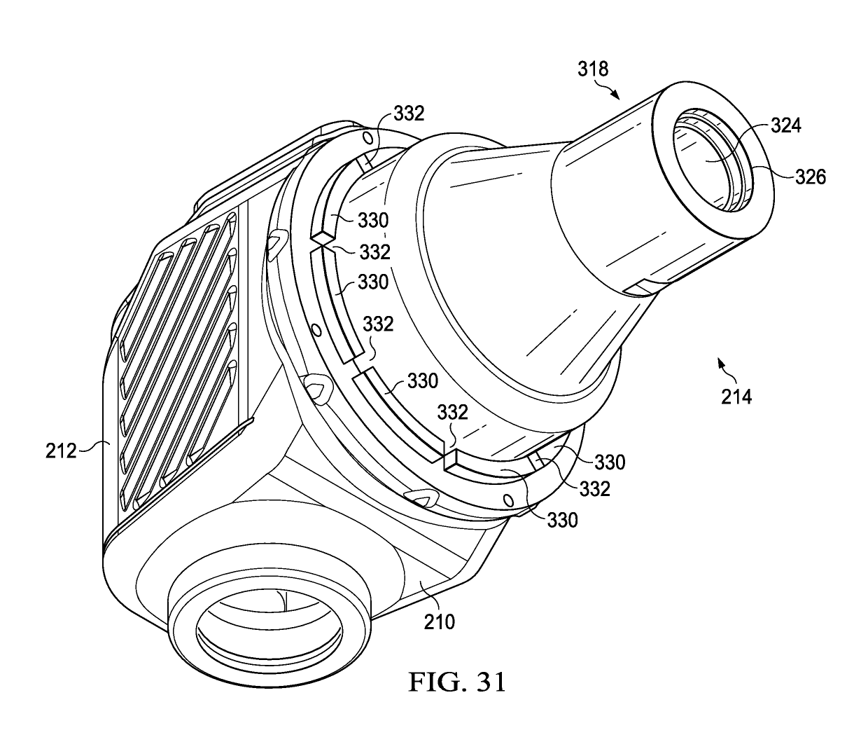

Referring now to FIGS. 2-3 and 31, the head assembly 214 can be rotatably coupled with the housing 31 and the linear motor 40. As illustrated in FIG. 31, the right and left portions 210, 212 of the head assembly 214 can be secured together (e.g., with bolts 316 shown in FIG. 4) and can cooperate to define a rear sleeve portion 318. As illustrated in FIGS. 2 and 5, the front collar 196 of the linear motor 40 can extend into the rear sleeve portion 318 such that the rear sleeve portion 318 is circumferentially disposed about the front collar 196. A grommet 320 can be sandwiched between the front collar 196 and the rear sleeve portion 318. The front collar 196 can define a groove 322 and the rear sleeve portion 318 can define an annular rib 324. The groove 322 can be machined or otherwise provided onto the outer housing 160. The rear sleeve portion 318 can also define a radial lip portion 326 that extends into or over a portion of the grommet 320. The groove 322, the annular rib 324, and the radial lip portion 326 can interact with the grommet 320 to facilitate rotatable coupling of the head assembly 214 to the linear motor 40 while preventing the rear sleeve portion 318 and the front collar 196 from being pulled apart. It will be appreciated that a rotating head can be coupled to a motor housing in any of a variety of other suitable embodiments.

When the head assembly 214 is rotated, the piston 44 can be configured to maintain engagement with the transmission assembly 64 and can rotate with respect to the piston housing 86. In one embodiment, as illustrated in FIGS. 2-3, a sleeve bearing 328 can be interposed between the shaft 70 of the piston 44 and the front collar 196. The sleeve bearing 328 can journal the shaft 70 of the piston 44 with respect to the front collar 196 such that the shaft 70 is permitted to rotate and reciprocate. The head assembly 214 is free to rotate with respect to the linear motor 40 among an infinite amount of different positions and without requiring removal of the head assembly 214 as is common in some conventional arrangements. As such, a user can selectively rotate the head assembly 214 to achieve a precise position.

The head assembly 214 can be configured for selective locking among different rotational positions. Referring again to FIG. 31, a plurality of indexing tabs 330 can be arranged circumferentially about the head assembly 214. Each pair of the indexing tabs 330 can define a slot 332 therebetween. As illustrated in FIGS. 1-4 and 32, the housing 31 can include a locking button 334 having a lower tab portion 336 that is configured for selective interaction with each of the slots 332 to facilitate locking of the head assembly 214 in different positions. When the locking button 334 is in a released position, as illustrated in FIG. 1, the lower tab portion 336 can extend into any of the slots 332 to rotatably lock the head assembly 214 in position. When the locking button 334 is slid rearwardly, the lower tab portion 336 can be retracted from entering any of the slots 332 to permit the head assembly 214 to rotate. The slots 332 are shown to be arranged such that the angular position of the head assembly 214 can be locked at about 45 degree intervals. It will be appreciated that if the locking button 334 is released when the lower tab portion 336 is not aligned with any of the slots 332, the head assembly 214 is still permitted to rotate between the nearest slots 332. However, once the lower tab portion 336 aligns with one of the slots 332, the lower tab portion 336 can automatically project into the slot 332 to lock the head assembly 214 in position. In one embodiment, the oscillating tool 30 can be configured with a cutoff switch (not shown) that enables operation of the linear motor 40 only when the head assembly 214 is locked in place (e.g., the lower tab portion 336 extends into one of the slots 332). In another embodiment, the oscillating tool 30 is free to operate irrespective of the locking of the head assembly 214. In such an embodiment, the position of the head assembly 214 can be provided at an infinite amount of different angles to allow the head assembly 214 to achieve cutting or other tool use at different angles, while keeping a user's hand(s) ergonomically positioned. In one embodiment, the head assembly 214 can include a stop arrangement that prevents continuous rotation of the head assembly 214 (e.g., beyond about 360 degrees). It will be appreciated that in other embodiments, a head assembly can be fixed with respect to a linear motor and/or a housing. For example, a head assembly and a housing can be formed together in a one-piece construction such that the head compartment and motor compartment are defined by the one-piece construction.

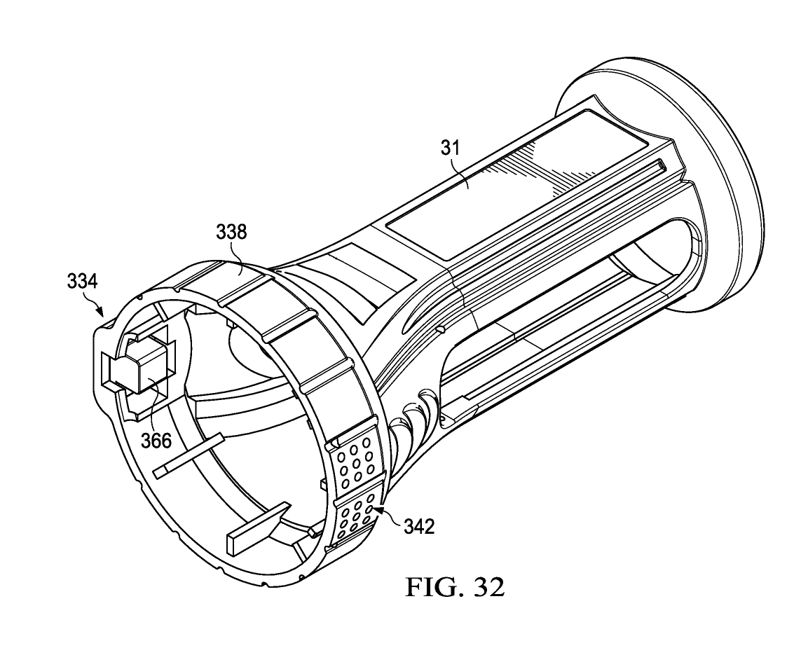

Referring again to FIG. 32, the locking button 334 can be supported along a cuff portion 338 of the housing 31. As illustrated in FIGS. 2 and 3, when the housing 31 is installed over the linear motor 40, the cuff portion 338 can overlie and conceal the indexing tabs 330. A decorative ring 340 can be sandwiched between the cuff portion 338 and the head assembly 214. In one embodiment, the decorative ring 340 can be formed of nylon and can be arranged to reduce vibration.

The cuff portion 338 can define a plurality of exhaust ports 342 that are in fluid communication with the exhaust ports 152, 165 of the piston housing 86 and the outer housing 160, respectively. The plurality of exhaust ports 342 can be located along a lower portion of the housing 31 (e.g., underneath the oscillating tool 30). When the pressurized air is exhausted from the exhaust ports 152, 165 of the piston housing 86 and the outer housing 160 respectively, the pressurized air can be routed between the housing 31 and the head assembly 214 (e.g., through the motor compartment 41) and through the exhaust ports 342 of the housing 31. In one embodiment, an air filter can be provided upstream of the exhaust ports 342 (e.g. attached directly to the cuff portion 338) to filter the exhaust air provided through the exhaust ports 342. The exhaust ports 342 can direct the pressurized air from the exhaust ports 152, 165 towards the accessory blade 38. The exhaust air can accordingly remove debris (e.g., sawdust) from around the accessory blade 38 which can enhance the ability of an operator to view the operation of the accessory blade 38 thereby enhancing precision and efficiency. The exhaust ports 342 can be located forwardly of the trigger assembly 46 (e.g., interposed between the trigger handle 60 and the plunger 256) to prevent a user's hand from interrupting the flow of the pressurized air to the accessory blade 38. In one embodiment, the exhaust ports 342 can be angled such that they are substantially parallel to the pivotal axis A1, but in other embodiments, the exhaust ports 342 can be angled towards the accessory blade 38. It will be appreciated that, in some embodiments, the pressurized air routed from the linear motor 40 to the exhaust ports 342 can facilitate cooling of the transmission assembly 64 and or the tool free attachment assembly 76.

Referring now to FIGS. 2-4 and 33-34, the oscillating tool 30 can include a flow control collar 344 that is rotatably coupled with the air inlet 36 and is rotatable with respect to the air inlet 36 to vary the operating speed of the linear motor 40. The control collar 344 can define a central passageway 346 that is bordered by an inner shoulder 348. The control collar 344 can include an outer shoulder 350 that is disposed radially outwardly from, and is raised with respect to, the inner shoulder 348. The flow control collar 344 can also include an outer cuff 352. As illustrated in FIGS. 2 and 3, the outer shoulder 350 of the flow control collar 344 can engage the rear backing plate 42 and the outer cuff 352 can engage the housing 31. A sealing member 354 (e.g., O-ring) can be sandwiched between the outer shoulder 350 and the rear backing plate 42 to provide a sealed interface. A sealing member 355 can also be sandwiched between the stem portion 37 of the air inlet 36 and the flow control collar 344. The flow control collar 344 can cooperate with the air inlet 36 and the rear backing plate 42 to define an air chamber 356.

The stem portion 37 of the air inlet 36 can extend through the central passageway 346 such that the inner shoulder 348 is radially disposed about the stem portion 37 and such that the air inlet 36 at least partially rotatably supports the flow control collar 344. The stem portion 37 can be secured to the rear backing plate 42, as described above, and the base portion 35 can abut the rearmost portion of the flow control collar 344 to restrain lateral movement of the flow control collar 344 relative to the rear backing plate 42 and the housing 31 (i.e., preventing the flow control collar 344 from being removed from the rear backing plate 42 and the housing 31).

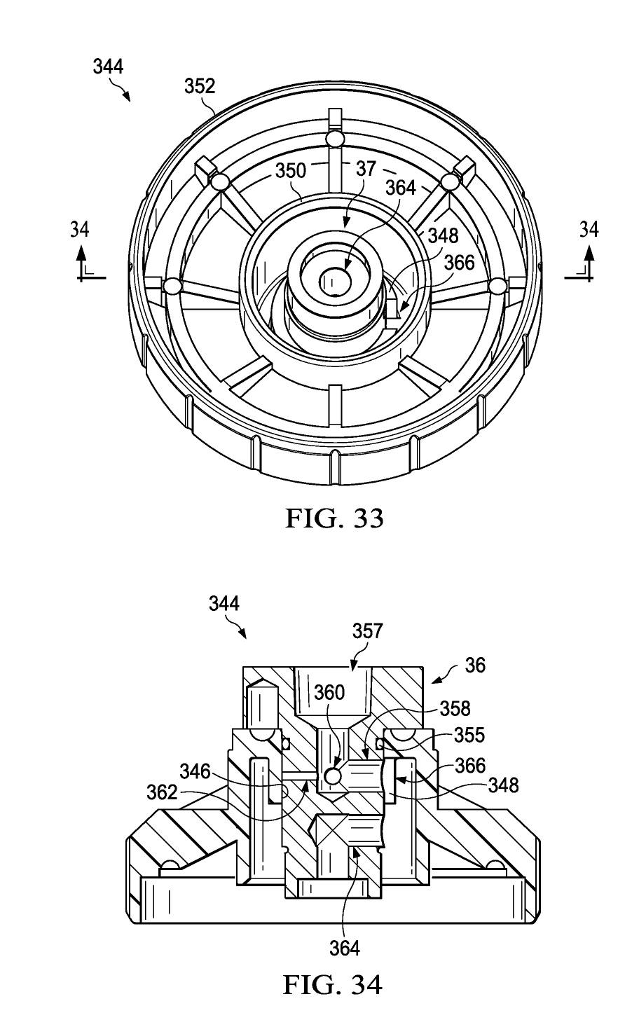

Referring now to FIGS. 33-36, the air inlet 36 can define an inlet passageway 357 that is in fluid communication with a first port 358, a second port 360, and a third port 362. Each of the first, second, and third ports 358, 360, 362 can extend radially outwardly from the inlet passageway 357. The air inlet 36 can also define an output passageway 364 that is substantially L-shaped. The output passageway 364 can be spaced entirely from the first, second, and third ports 358, 360, 362 such that the output passageway 364 does not fluidly communicate through the air inlet 36 with any of the first, second, and third ports 358, 360, 362.

As will be appreciated with reference to FIG. 33, the first, second, and third ports 358, 360, 362 of the air inlet 36 can be disposed below the inner shoulder 348 of the flow control collar 344 and the output passageway 364 can be disposed above the inner shoulder 348. As illustrated in FIG. 33, the inner shoulder 348 can define a notch 366. The flow control collar 344 can be rotated to align the notch 366 with different ones of the first, second, and third ports 358, 360, 362. When the notch 366 is aligned with a port, that port is in fluid communication with the air chamber 356 such that air can flow through the aligned port, into the air chamber 356 and through the output passageway 364 to power the linear motor 40. The ports which are not aligned with the notch 366 can be blocked by the inner shoulder 348 to prevent fluid communication between those ports and the output passageway 364.

As illustrated in FIGS. 33-36, each of the first, second, and third ports 358, 360, 362 can have different diameters such that each of the first, second, and third ports 358, 360, 362 can provide pressurized air to the output passageway 364 at different fluid pressures. The operating speed of the linear motor 40 can vary in response to the different fluid pressures from the first, second, and third ports 358, 360, 362. For example, when the first port 358 is aligned with the notch 366, the air pressure provided to the linear motor 40 can be greater than the air pressure provided by either of the second or third ports 360, 362 such that the linear motor 40 operates at a maximum speed. When the second port 360 is aligned with the notch 366, the air pressure provided to the linear motor 40 can be less than the air pressure from the first port 258 but greater than the air pressure from the third port 262 such that the linear motor 40 operates at a moderate speed. When the third port 362 is aligned with the notch 366, the air pressure provided to the linear motor 40 can be less than the air pressures from either the first and second ports 258, 260 such that the linear motor operates at a minimum speed.

As illustrated in FIGS. 2-4, a detent arrangement 368 can be housed in a recess 370 defined by the base portion 35 of the air inlet 36. The detent arrangement 368 can include a detent 372 and a spring 374 that biases the detent 372 into contact with the flow control collar 344. As illustrated in FIG. 38, the flow control collar 344 can define a plurality of indexing recesses 376. When the flow control collar 344 is rotated, the detent 372 can selectively and alternatively engage the indexing recesses 376 to maintain the flow control collar 344 in one of four different positions. Three of the different positions can align a different one of the first, second, and third ports 358, 360, 362 with the notch 366 such that the linear motor 40 is selectively operable at three different speeds (e.g., a maximum speed, a moderate speed, and a minimum speed, respectively). In one embodiment, the fourth position can correspond to each of the first, second, and third ports 358, 360, 362 being blocked by the upper shoulder 348 such that linear motor 40 does not operate. In other embodiments, an air inlet can be provided with only two ports or more than three ports. It will be appreciated that, in other embodiments, the inlet valve might be provided with only two ports or might more than three ports and the flow control valve can be configured accordingly to provide varying degrees of speed variation of the linear motor 40.

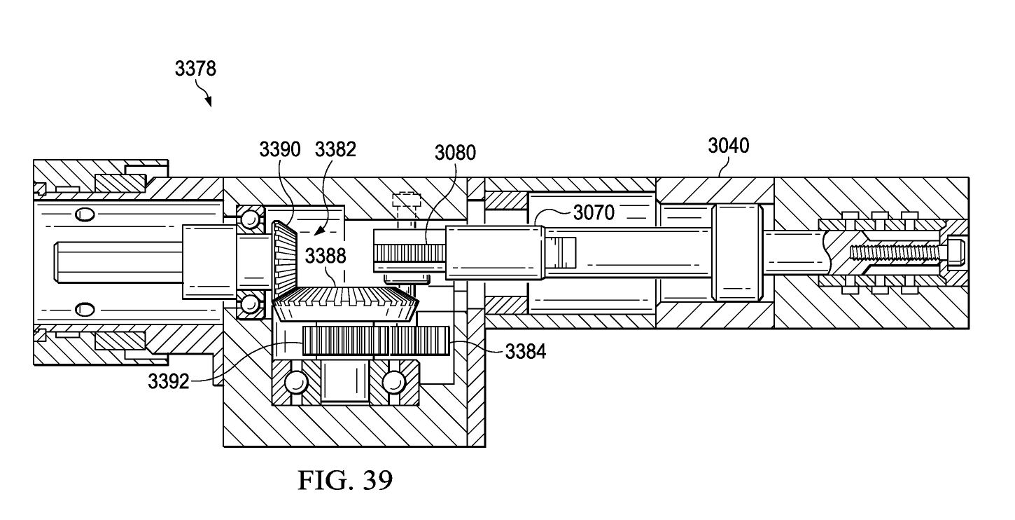

FIGS. 39-42 illustrate an alternative embodiment of a linear motor 3040 in conjunction with a rotary transmission 3378. The linear motor 3040 can be, in many respects, similar to, or the same as, the linear motor 40 shown in FIGS. 1-6. However, as illustrated in FIG. 39, a shaft 3070 of a piston of the linear motor 3040 can include a pair of gear racks 3080 (e.g., geared surfaces), each disposed on opposite sides of the shaft 3070. The gear racks (e.g., 3380) can be machined or otherwise provided on the shaft 3070 in any of a variety of suitable alternative arrangements. For example, the gear racks 3080 can be welded, brazed, or formed as a one-piece construction (e.g., pressed onto the shaft 3070). The rotary transmission 3378 can include a pair of pinion gears 3382, a pair of lower gears 3384, a pair of one-way bearings 3386, a spiral bevel gear 3388, a spiral pinion gear 3390, and a central gear 3392. The pinion gears 3382 can be operably coupled with the pair of lower gears 3384 by the one-way bearings 3386. The lower gears 3384 can each be intermeshed with the central gear 3392. The central gear 3392 can be coupled with the spiral bevel gear 3388 which is intermeshed with a spiral pinion gear 3390.

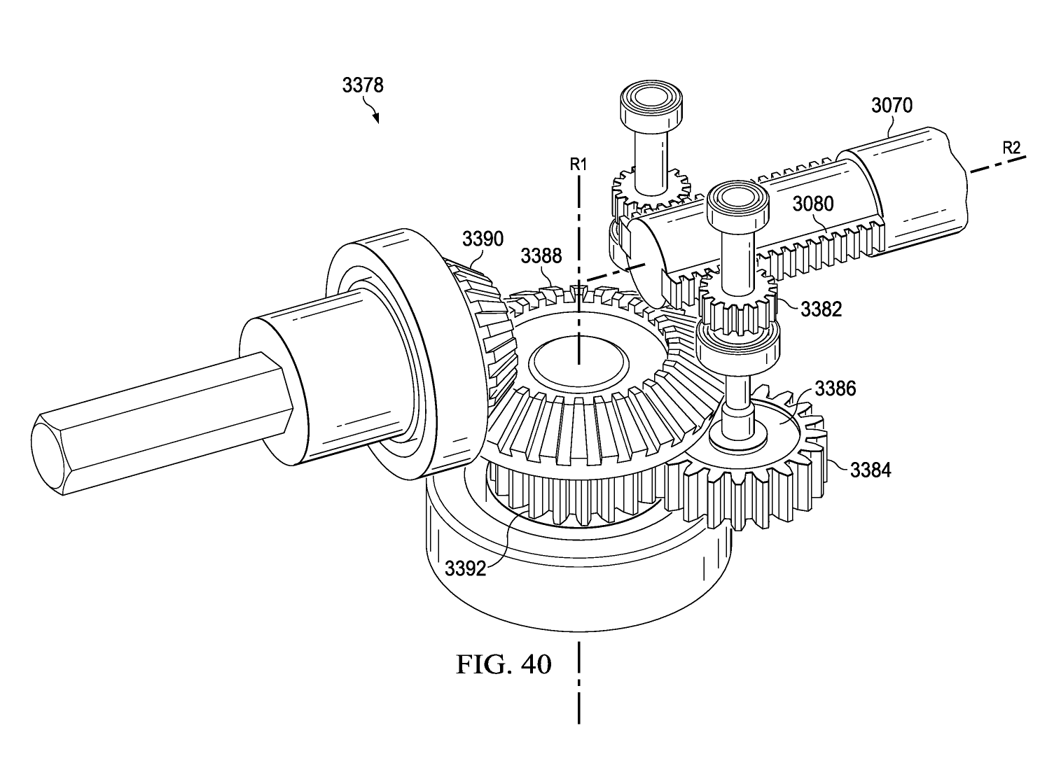

The shaft 3070 can be sandwiched between the pair of pinion gears 3382. The gear racks 3080 can be intermeshed with the pinion gears 3382 such that reciprocation of the shaft 3070 can rotate the pinion gears 3382 simultaneously and in opposite directions. The counter-clockwise rotating pinion gear 3382 can drive its associated lower gear 3384 in a counter-clockwise direction to rotate the central gear 3392 in a clockwise direction. The clockwise rotating pinion gear 3382 can rotate freely with respect to its associated lower gear 3384 due to its associated one-way bearing 3386. As the shaft 3070 reciprocates, one of the pinion gears 3382 can be rotated counter-clockwise, which can facilitate continuous rotation of the central gear 3392 in a clockwise direction about a rotational axis R1 (FIG. 40) in response to the reciprocation of the shaft 3070. This rotation of the central gear 3392 can rotate the spiral pinion gear 3390 in a counter-clockwise direction. An output shaft (not shown) can be coupled with the spiral pinion gear 3390 and an accessory, such as a cutting disc or a drill bit, can be coupled with the output shaft. When the hand-held rotary pneumatic tool is operated, the accessory can be rotated by the output shaft. It will be appreciated that, in other embodiments, the drive direction of any or all of these various components can be reversed.

As in the embodiment of FIGS. 39-42, the accessory can accordingly rotate about an axis that is coaxial with, or substantially parallel to, the reciprocation axis of the shaft 3070 (e.g., the axis R2 illustrated in FIG. 40). In one embodiment, the output shaft can include a tool free attachment assembly to facilitate coupling of an accessory (e.g., a drill bit or cutting wheel) to the hand-held pneumatic rotary tool, but in other embodiments, an accessory can be selectively coupled with the output shaft in any of a variety of other suitable arrangements.

In an alternative embodiment, the rotary tool can be arranged as a right-angle type hand tool. In such an embodiment, an output shaft can be coupled with a central gear (e.g., 3392) such that the output shaft can rotate about an axis that is substantially perpendicular to the reciprocation axis of the piston (e.g., the axis R1 illustrated in FIG. 40). A spiral bevel gear (e.g., 3388) and spiral pinion gear (e.g., 3390) can accordingly be omitted from the right-angle design, which can reduce the overall size, weight, complexity and cost of the rotating head.

Through use of a linear motor and conversion of oscillating motion into rotary motion such as shown and described with reference to FIGS. 39-42, a smaller quantity of compressed air can be required for a hand-held pneumatic rotary tool to accomplish a particular task, as compared with conventional hand-held pneumatic rotary tools that incorporate a rotary vane-type motor. Reducing the required quantity of compressed air can allow use of a smaller and less powerful air compressor, and can provide energy and cost savings.

It will be appreciated that some of the features described above, such as the tool free attachment assembly 76, the head assembly 214, and the accessory disk 258, for example, can be provided on electric motor-type oscillating tools as well as other types of pneumatic-type oscillating tools, and that others of the features above, such as the arrangement of the exhaust ports 342, can be employed on other types of pneumatic hand-tools.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

1. A hand-held tool comprising:
a housing defining a motor compartment;
a head assembly defining a head compartment;
an air inlet supported by the housing;
a pneumatic linear motor disposed at least partially within the motor compartment and comprising a piston, the piston comprising a shaft, wherein the piston is configured for reciprocation between a forward position and a rearward position;
a transmission assembly coupled to the shaft and disposed at least partially within at least one of the motor compartment and the head compartment;
at least one resilient member disposed at least partially within the head compartment adjacent the transmission assembly and configured for selective contact with one of the transmission assembly and the shaft when the piston is in one of its forward position and rearward position to facilitate dampening of the piston.

2. The hand-held tool of claim 1 wherein said at least one resilient member is disposed forwardly of the transmission assembly and is configured for selective contact with the transmission assembly.

3. The hand-held tool of claim 2 wherein said at least one resilient member is configured for selective contact with the transmission assembly when the piston is in the forward position.

4. The hand-held tool of claim 1 wherein said at least one resilient member comprises a pair of bumper members.

5. The hand-held tool of claim 4 wherein the pair of bumper members are formed of a fluoroelastomer having a durometer value of between about 65 and about 85.

6. The hand-held tool of claim 1 wherein the transmission assembly comprises a cam that defines a slot.

7. The hand-held tool of claim 6 wherein said at least one resilient member is disposed forwardly of the cam and configured for selective contact with the cam when the piston is in a forward position.

8. The hand-held tool of claim 7 wherein said at least one resilient member comprises a pair of bumper members.

9. The hand-held tool of claim 8 wherein the pair of bumper members are formed of a fluoroelastomer having a durometer value of between about 65 and about 85.

10. A hand-held tool comprising:
a housing defining a motor compartment;
a head assembly rotatably coupled with the housing and defining a head compartment;
a linear motor disposed at least partially within the motor compartment and comprising a piston, the piston comprising a shaft and being configured for reciprocation;
a transmission assembly coupled to the shaft and disposed at least partially in at least one of the motor compartment and the head compartment;
wherein each of the transmission assembly, the piston and the head assembly are rotatable together.

11. The hand-held tool of claim 10 wherein the linear motor comprises a pneumatic linear motor.

12. The hand-held tool of claim 11 wherein the head assembly is further configured for selective locking among different rotational positions relative to the housing.

13. The hand held tool of claim 12 further comprising:
a plurality of indexing tabs arranged circumferentially about the head assembly, wherein pairs of the indexing tabs cooperate to define respective slots therebetween; and
a locking button having a lower tab portion configured for selective interaction with each of the slots to facilitate locking of the head assembly in different angular positions.

14. The hand-held tool of claim 13 wherein the slots are arranged such that the angular position of the head assembly can be locked at about every 45 degrees.

15. The hand-held tool of claim 10 wherein the head assembly is further rotatably coupled to the pneumatic linear motor.

16. The hand-held tool of claim 10 wherein the pneumatic linear motor further comprises an outer housing and each of the transmission assembly, the piston and the head assembly are rotatable together with respect to the outer housing.

17. A hand-held tool comprising:
a housing defining a motor compartment;
a head assembly defining a head compartment;
an air inlet supported by the housing;
a pneumatic linear motor disposed at least partially within the air motor compartment and comprising a piston, the piston comprising a shaft, wherein the piston is configured for reciprocation along a longitudinal axis;
a transmission assembly disposed at least partially in at least one of the motor compartment and the head compartment, the transmission assembly comprising a cam that defines a slot, wherein a centerline bisects the slot and the slot is angled with respect to the longitudinal axis such that the centerline and the longitudinal axis form an acute angle.

18. The hand-held tool of claim 17 wherein the centerline is angled from the longitudinal axis by an angle greater than about 30 degrees.

19. The hand-held tool of claim 17 wherein the cam is pivotally coupled with the shaft.

20. The hand-held tool of claim 17 further comprising an accessory attachment mechanism that comprises a bearing that is disposed within the slot and interacts with the slot to facilitate pivoting of the accessory attachment mechanism about a pivotal axis.

21. A hand-held tool comprising:
a housing defining a motor compartment;
an air inlet supported by the housing;
a pneumatic linear motor disposed at least partially within the air motor compartment and comprising a piston, the piston comprising a shaft, wherein the piston is configured for reciprocation along a longitudinal axis; and
a transmission assembly disposed at least partially in one of the motor compartment and the head compartment, the transmission assembly comprising:
a boss coupled to the shaft of the piston; and
a cam pivotally coupled with the boss and configured to interact with a support a bearing of an accessory attachment mechanism to facilitate pivoting of the accessory attachment mechanism about a pivotal axis.

22. The hand-held tool of claim 21 wherein the cam that defines a slot, a centerline bisects the slot, and the slot is angled with respect to the longitudinal axis such that the centerline and the longitudinal axis form an acute angle.

23. The hand-held tool of claim 22 wherein the centerline is angled from the longitudinal axis by an angle greater than about 30 degrees.

24. The hand-held tool of claim 21 further comprising at least one resilient member disposed forwardly of the cam and configured for selective contact with the cam when the piston is in a forward position to facilitate dampening of the piston.

25. The hand-held tool of claim 24 wherein said at least one resilient member comprises a pair of bumper members formed of a fluoroelastomer having a durometer value of between about 65 and about 85.

26-52. (canceled)
